(19) United States
(12) Patent Application Publication
(10) Pub. No.: US 2004/0254879 A1
(43) Pub. Date: Dec. 16, 2004

(54) Fixed rate gradually stepped payment loan

(76) Inventor: Wendell Dickerson, Katonah, NY (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/808,611

(22) Filed: Mar. 25, 2004

Related U.S. Application Data
(63) Continuation-in-part of application No. 10/402,244, filed on Mar. 31, 2003.
(60) Provisional application No. 60/368,161, filed on Mar. 29, 2002.
(60) Provisional application No. 60/370,692, filed on Apr. 9, 2002.

(51) Int. Cl. G06F 17/60

(52) U.S. Cl. 705/38; 705/40

(57) ABSTRACT

A gradually stepped payment (GSP) mortgage loan at a fixed rate of interest has payments that are gradually increased over much or all of the loan term. The payments may be increased monthly, annually or on other schedules. The increments are predefined at the beginning of the loan so that the borrower may account for and predict the changes. The general method for creating the GSP loan is to start with a predefined loan amount, initial payment amount, interest rate and loan term. Given these four constants, a lender calculates the growth rate by which the loan payments increase to produce a desired present value for the total GSP payments. The growth rate may also be affected by other predefined factors affecting the current value calculations, such as the timing and duration of the payment increases. The growth rate is likely to be a unique multi-decimal number, as opposed to a full or half percent (or combination thereof). With the GSP loan, the stream of increasing loan payments has a present value equal to than the present value for a stream of constant payments associated with a conventional fixed rate self-amortizing loan of comparable interest rate, term and amount.

### CROSS REFERENCE TO RELATED APPLICATIONS

This application is a continuation-in-part application of pending U.S. patent application Ser. No. 10/402,244 filed on Mar. 31, 2003, the disclosure of which is hereby also incorporated by reference in its entirety. The application further claims priority from U.S. Provisional Application Nos. 60/368,161 filed Mar. 29, 2002 and 60/370,692 filed Apr. 9, 2002, the subject matter of which is hereby incorporated by reference in their entirety.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to a system and method for forming an improved lending instrument. In particular, the present invention provides a residential mortgage loan having lower initial payments and/or smaller payment duration for borrowers while offering the potential of increased profits for lenders.

2. Description of the Related Art

Many types of loans are known in the field of finance and mortgages. One type of known loan is a conventional self-amortizing fixed rate mortgage. The conventional mortgage has a stream of fixed monthly payments that do not change over the life of the loan. As depicted in a conventional loan payment chart 10 of FIG. 1 (Prior Art), the convention loan has a fixed conventional payment amount 11. These fixed payments are defined at the beginning of the loan according to the borrowed amount, interest rate and term of the loan (described below). With a conventional loan, each of the fixed payments has a principal portion that is used to reduce the debt to the lender and an interest portion that is used to pay the lender interest on the remaining debt. In the conventional loan payment chart 10, the interest portion of the payments is represented by Pᵣ. In the initial payments, the amount of remaining debt is large, so the interest portion is relatively large compared to the principal portion (the difference between Pᵣ and the payment amount 11). In other words, the borrower is initially paying mostly interest, with only a small portion of the payment being applied toward reducing the owed principal.

Each month, the amount of principal repaid (amortized), increases [by] according to the interest rate of the loan, creating a series of steadily increasing principal payments called a “sinking fund,” and at the end of the loan, the sum of those principal payments equals the loan amount borrowed at origination. With later payments, much of the debt has been already repaid to the lender, so the interest portion of the payment is much less and the principal portion is a relatively greater percentage of the fixed payment. As a result, amortization by sinking fund enables borrowers to make the same total payment of interest and principal each month, whereby each successive payment consists of a slightly higher portion of principal and a correspondingly lower amount of interest. Thus, as depicted in a conventional principal payment chart 20 in FIG. 2 (PRIOR ART), the amount of principal paid in the conventional loan is relatively small at first but rapidly increases toward the end of the loan payment period.

Many borrowers prefer the conventional mortgages because of the predictability of the payments. In this way, the borrowers can avoid future uncertainty. Over time, with inflation and growth of real income, the fixed payments of the conventional loan generally become relatively easier to pay. The initial payments, however, may be difficult for many borrowers. This problem is particularly noticeable in periods of high interest rates, since the higher interest rates result in increased monthly payments.

Another type of known loan instrument is an adjustable rate loan or mortgage (ARM). ARMs are popular with some borrowers because these loans usually offer lower initial payments in comparison to a conventional mortgage. With an ARM, the repayment amounts are not fixed over the life of the loan and may vary according to predefined conditions. Typically, the repayment amounts are fixed in the short term, but are periodically or intermittently reset to reflect prevailing market interest rates. The ARM payments are typically pegged to a benchmark interest rate. Payments for a one-year ARM can increase as much as two full percentage points a year up to six percentage points in as few as three years if the benchmark rises. Other ARMs offer a fixed rate for a few years, after which it is reset to market.

Also, the ARMs may be relatively expensive for lenders to administer because of the costs of monitoring the benchmarks and notifying the borrowers of payment changes.

Because borrowers assume the risks associated with increases in interest rates, ARMs offer lower initial rates. However, ARMs expose borrowers to the significant risk of sizable near-term increases in payments if interest rates rise. With rising interest rates, many borrowers may not be able to afford the higher payments. In particular, many borrowers use ARMs to qualify for larger mortgages (based upon the lower initial payments) and cannot afford even small increases in loan payments. Even where the increases in payment are capped (such as the 2 percentage points described above), mortgage payments can quickly surpass the financial resources of many borrowers, causing these borrowers to default on payments.

Accordingly, there exists a need for a lending instrument having lower initial payments without exposing borrowers to risks associated with interest rate changes. There is similarly a need for a loan instrument having lower initial payments and lower administrative costs to lenders.

Another type of known lending instrument is a graduated payment mortgage (GPM). In a GPM, initial payments begin relatively low, usually below the payment for equivalent 30-year conventional fixed payment loans, and then the GPM payments step (increase each year of the loan) until reaching a payment that remains constant to maturity. One kind of GPM was formed using a predefined period during which payments would increase, the growth rate by which they would increase, the amount of the loan, its interest and its duration (term) and then solving for the initial payment amount, as described below. In another embodiment, a lender began with a predefined initial payment, the growth rate, and the periods during which payments would increase, and then solved for the subsequent final payments needed to repay the borrowed principal over the remaining term of the loan.

The GPM was created to make home ownership more affordable in the high (double-digit) interest rate environment of the 1980's. The amount people could borrow was determined by the first year's payment, which started below the GPM's fixed interest rate, increased for the first 5 to 10 years of a 15 to 30 year term, and remained constant thereafter. The FHA guaranteed the GPM as a means of bringing home ownership within the reach of lower income families. One guaranteed GPM increased 7.5% per year for five years, and a more conservative GPM stepped 2% annually for 10 years, but in all cases the steps were in increments of a full or half percentage point. Annual increases of 7.5% for 5 years meant that payments could rise about 44% in a relatively short time frame, which would strain the incomes of all but a few families who needed the lower initial payments to qualify for the loan. Even the smaller increases of 2% for 10 years could have been too high for many families whose incomes might not keep pace with such increases.

Turning now to a GPM payment chart 30 in FIG. 3 (PRIOR ART), GPM payment amounts 31 are initially lower than the conventional payment amount 11. The GPM payment amounts 31 may be even lower than the interest only portion Pᵣ of the conventional payment amount 11. Subsequently, the GPM payment amounts 31 increase, as described above, until settling at a fixed GPM payment amount 31a in year y. As suggested by GPM payment chart 30, the GPM payment amounts 31 may increase rapidly during the loan period. Thus, most lenders would be well advised to discourage borrowers from GPMs unless the borrowers are certain of future income increases.

In addition to the risk inherent in their rapidly growing payments, default risk for GPM loans also can be heightened by negative amortization. With first year payments as much as three percentage points less than a contract rate for an interest-only payment, the balance on a GPM loan generally increased and became a progressively higher percentage of the purchase price of a home before it began to amortize. In other words, some the interest due on the GPM loan would not be initially repaid and would instead be capitalized or added to owed principal. As depicted in a GPM principal accumulation chart 40 in FIG. 4 (PRIOR ART), the negative amortization causes the borrower to owe increasing amounts of principal at the start of the loan because the initial GPM payments are lower than the interest due on the loan (Pᵣ). Specifically, the amount of the unpaid interest initial is added to the principal owed on the GPM loan, increasing the borrower's debt level. Eventually, the GPM payment amounts increase so that negative equity and the original principal due on the loan can be repaid.

Since conventional fixed payment mortgages would begin to amortize after closing, GPM loans pose a higher default risk and could therefore command a higher yield. The higher yield may have initially attracted some lenders and investors, but few lenders actually fully realized these higher yields. Instead, most GPM borrowers avoided the rapidly increasing annual payments by prepaying their GPM loans and refinancing with ARM's or conventional fixed payment mortgages at lower payment levels. Thus, lenders have found that there is little benefit in originating GPM loans because they are typically pre-paid quickly as their payments increased. The GPM loans were designed for high interest rate environments to reduce initial payments. Once the level of interest rates fell into a single digit environment, neither lenders nor borrowers saw a need for significant reductions in initial payments. Currently, GPM loans are no longer commonly made and, accordingly, GPMs are not commercially successful lending instruments.

Another known type of lending instrument developed during times of high interest rates in the early 1980's is the growing equity mortgage (GEM). In the GEM loan, the first-year payments were equal to the fixed payment of a comparable 30-year conventional mortgage and, similar to the GPM mortgages, the GEM payments for subsequent years increased by increments of full or half percentage points, by 1% to 7.5% each year. The predefined steps of the GEM payments were allocated to the repayment of principal and produced a loan of shorter duration. The primary objective of the GEM mortgages was rapid amortization and, depending on the growth rate, repayment of the loan in, as few as, 15 to 20 years. Accordingly, lenders typically offered GEM mortgages with annual increases of 2% or more to achieve the desired shortening of the repayment period.

Turning now to a GEM payment chart 50 of FIG. 5 (Prior Art), the GEM payment amount 51 starts approximately equal to the conventional payment amount 11 and increases from this level to maturity. As can be inferred from the GEM payment chart 50, the GEM payment amount 51 is always larger than the conventional payment amount 11 for an equivalent loan. The additional portion of the GEM payment amount 51 (i.e., the amount above the conventional payment amount 11) is applied directly to the principal due on the loan. Thus, the borrower of the GEM loan repays the borrowed principle much more rapidly, as depicted by GEM principal repayment chart 60 in FIG. 6 (PRIOR ART), in comparison to the principal repayment with a conventional loan (indicated by the dashed line). In particular, as depicted in FIGS. 5 and 6, the GEM loan is repaid in full in year y₀, which occurs before the repayment of the equivalent conventional fixed payment loan.

The GEM loans have never been popular with borrowers. The borrowers have been apprehensive that the large increases in the GEM mortgage payments could outpace income increases. Thus, as with GPM loans, very few GEM loans are made and GEMs are not commercially successful.

### BRIEF SUMMARY OF THE INVENTION

In comparison to the lending instruments described above or otherwise known in the field of lending and finance, the present invention provides for a gradually stepped payment (GSP) mortgage loan at a fixed rate of interest. In the GSP loan, payments are slowly increased over much or all of the loan term. The payments may be increased monthly, annually or on other schedules. The increments are predefined at the time the loan is made so that the borrower may account for and predict the changes.

The general method for creating the GSP loan is to start with a predefined loan amount, initial payment amount, interest rate and term. Given these four constants, a lender calculates the growth rate by which the loan payments increase to produce a GSP payment schedule having a present value (as defined hereafter) equal to the borrowed principal. The growth rates may also be affected by other predefined factors affecting the current value calculations, such as the timing and duration of the payment increases. Specifically, the GSP loan has a stream of increasing loan payments with a present value equal to the present value for a stream of fixed payments associated with a conventional fixed rate self-amortizing loan of comparable interest rate, term and amount. In this way, the GSP loan will be revenue neutral for lenders in comparison to a conventional loan.

Accordingly, it should be recognized that the GSP loan differs from known lending instruments, such as those described above, because the growth rate and resulting payment steps are not predefined, but instead, are derived to achieve the desired present value. Therefore, GSP loans are very unlikely to have payments that increase precisely by increments of a whole or half percentage point characteristic of GPM and GEM loans but rather by a unique growth rate needed to achieve a precise present value for a loan with a predetermined interest rate, initial payment, term, and principal amount.

Various methods may be chosen to select an initial payment amount for the GSP loan. Generally, the initial payment may be set at virtually any amount. In a simple embodiment, the initial payment equal the interest portion of a conventional loan payment. With this initial payment, the lender will have the lowest possible initial payment without incurring negative amortization, in which unpaid interest must be capitalized and added to the principal amount of the loan. In this embodiment, the GSP loan is not substantially riskier to a lender than a conventional fixed rate loan because the equity owed on the loan does not increase. A higher initial payment will result in lower increases during the life of a given GSP loan to achieve the same present value. Thus, a higher initial payment may be used to create GSP loans that are amortized (repaid) more quickly. If the initial payment is set equal to or greater than the constant payments for an equivalent fixed rate conventional mortgage, then even very small increases in payments will achieve a shorter loan duration.

Likewise, various methods and schemes may be chosen for increasing the GSP payments. For instance, the payments in a GSP loan may have an annual growth rate, whereby the loan payments increase by the same percentage every year throughout the life of the loan. Alternatively, the loan payments may increase for a portion of the loan and then plateau for the remainder of the loan. To achieve a desired a desired present value, the GSP loan may have a relatively long period of growing payments or a shorter period with payments that increase more rapidly before leveling off. For a given initial payment, the shorter the desired term of a GSP loan the greater will be the growth rate required to achieve a desired present value. Obviously, the method and amounts of increases may also vary over the life of the loan as necessary to achieve desired payment amounts and duration, so long as the resulting GSP loan has the desired present value. During certain periods of a GSP loan, the borrower may choose to hold payments flat or, while unlikely, even have them decrease over time (i.e., payments with a negative rate of growth).

When possible, the increments in GSP loan payments should be kept relatively small so that total payments will not exceed the ability of the borrower to pay. Preferably, the yearly rate of increase in loan payments would be below 2 percent. In this way, the rate of increase in loan payments would be generally below expected rates of inflation and income growth so that the payments do not outpace the expected increases in a borrower's income. As a result, the possibility of default should not increase materially as the loan payments increase.

In another implementation of the GSP loan, the borrower may pay a fee (or “buydown”) to reduce the initial GSP payments or to secure a larger loan. This may be useful incases where the initial GSP loan payments desired are less than the interest due on the principal. To prevent capitalization of the unpaid interest, the lender may charge an initial fee that is used to pay for the unpaid interest until the GSP loan payments increase sufficiently to cover the interest costs. In this way, a borrower with sufficient savings to pay the buydown fee may obtain a larger loan without substantially increasing the risk to the lender or the costs to the borrower. Alternatively, the buydown fee may be borrowed by adding it to the balance of the GSP loan. With a buydown, the GSP loan still would be formed by deriving the specific rate at which payments must increase to yield a given present value using a predetermined initial payment, interest rate, loan amount and term.

Overall a GSP loan offers numerous advantages to borrowers. Specifically, a GSP loan provides the borrower with increased purchasing power. First time buyers often cannot afford the homes they want because lenders will not allow their aggregate mortgage, insurance and real estate tax payments to exceed a certain percent of their current income. However, by qualifying on the basis of a GSP mortgage's lower initial payments (that subsequently increases at a modest pace), borrowers would be able to safely borrow more than they could with a conventional loan. This increased purchasing power can make a huge difference to first time buyers. In the case of lower income families, it can enable them to borrow more money and buy homes with less reliance on government subsidies.

At the same time, the GSP loan further provides borrowers with predictable payments because the loan payments are defined at the beginning of the loan. In this way, the GSP loan avoids the risk of potentially large increases in loan payments from higher interest rates.

The GSP loan may also provide the borrower with substantial savings through lower initial loan payments. First time homebuyers and/or lower income families often prefer smaller payments in the short-term, and the GSP loan may allow borrowers to save significant amounts before its payments begin to exceed the constant payments of a comparable fixed rate conventional loan.

The GSP loan likewise provides numerous advantages to lenders and investors. Primarily, the GSP loans may allow the lender to achieve a higher yield with lower administrative costs. If a borrower needs a GSP mortgage to borrow more money than the borrower could with a conventional loan, he or she may be willing to pay more interest or fees. Even if the borrower does not need a larger loan, he or she may be more concerned with cash flow than interest rate and, therefore, happy to pay a bit more for a GSP loan with lower near term payments. Since the GSP loan's more gradual amortization means lenders will be paid back more slowly, the lender can justify charging a higher yield or up front fee.

Another benefit provided by the GSP loan to lenders is to lower default risk. Whereas borrowers with adjustable rate mortgages are exposed to considerable default risk because their payments can increase so much in a short period of time, the increases in GSP loans are gradual and pose much less risk. In addition, for lower income homebuyers and other borrowers who avail themselves of programs that require as little as a 3% down payment to purchase a home, the lower early payments of a GSP mortgage will reduce the strain on their income and thereby decrease the risk that they will default on their mortgages.

A GSP loan also gives lenders the benefit of reduced volatility. As long as the payments of a GSP mortgage are lower than a comparable conventional loan, borrowers would be less likely to pre-pay the GSP loan. Such reduction in volatility would be appealing to lenders and investors who own portfolios of residential mortgage loans.

Still another benefit that is provided to lenders and investors by GSP loans is lower portfolio risk. By adding GSP mortgages and decreasing their allocation of ARM's, companies would reduce the overall default risk of their portfolios. In addition, as a means of dealing with problem loans, GSP mortgages would be an affordable alternative that lenders could offer borrowers having trouble keeping up with rising payments on their adjustable rate mortgages.

A further advantage of GSP loans is that they are relatively simple to manage. Since the payments are predetermined for the life of the GSP loan, from closing to maturity, GSP mortgages should be easier and less costly to administer than ARMs, whose payments must be reset periodically to reflect changes in their benchmark rates.

### BRIEF DESCRIPTION OF THE DRAWINGS

These and other advantages of the present invention are described more fully in the following drawings and accompanying text in which like reference numbers represent corresponding parts throughout:

FIGS. 1, 3, and 5 (Prior Art) depict the payment trends for the known lending instruments formed in FIGS. 7-9;

FIGS. 2, 4, and 6 (Prior Art) the relative abilities of the known lending instruments formed in FIGS. 7-9 to pay back borrowed principal;

FIGS. 7-9 (Prior Art) depict the formation of known lending instruments;

FIG. 10 depicts the steps in a method for forming a GSP Loan in accordance with embodiments of the present invention;

FIGS. 11-23 are tables depicting examples of GSP loans formed in accordance with embodiments of the present invention, and

FIG. 24 depicts a GSP payment schedule formed with the method of FIG. 10 in accordance with embodiments of the present invention.

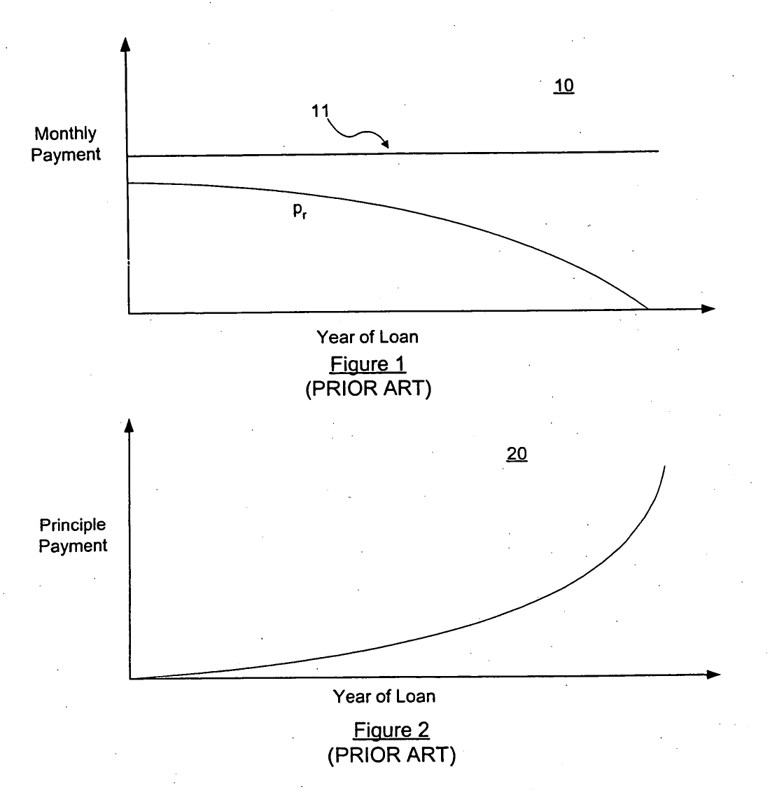

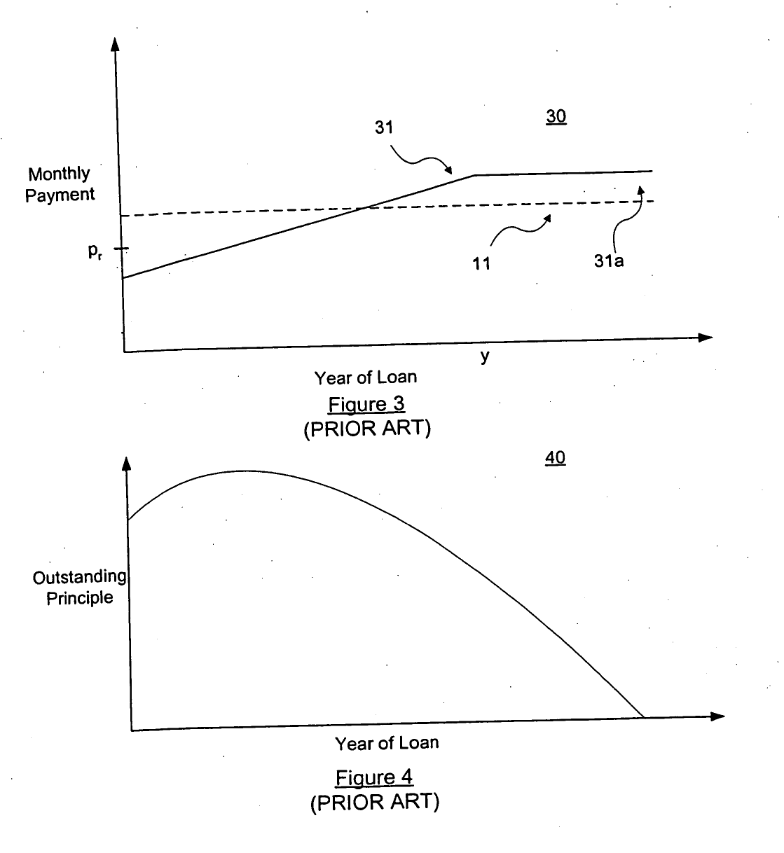

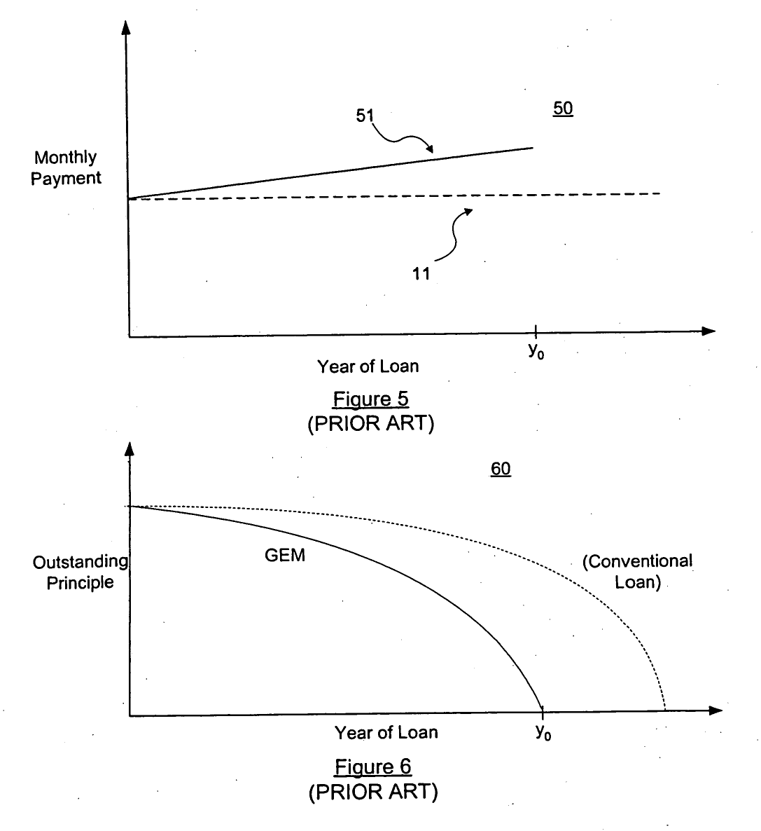

### DETAILED DESCRIPTION OF THE INVENTION

As depicted in FIG. 7, a conventional loan formation 70 uses several input variables, including an amount of borrowed principal 1, an interest rate of the loan 2, and a term of, the loan 3. In step 4, the monthly payments are then determined to so that the present value of the stream of the loan payments equals the borrowed principal 1.

Present value is based on the assumption that, because money invested today will be worth more in the future, people will pay less today for an amount of money to be received in the future. An amount x today invested at an interest rate r would be worth x*(1+r)ⁿ in n years. Conversely, an amount y to be received in n years would be worth (have a present value of) y/(1+r)ⁿ today. The process of calculating the present value of a future amount of money by dividing it by the sum of 1 plus the interest rate r compounded for n years is called discounting, where r is referred to as the discount rate. Payments increased by (1+r/12)^{n/12} are said to be compounded monthly, and their present value is calculated by discounting monthly by (1+r/12) ^{n/12}. Accordingly, the present value of a stream of monthly payments is defined in Equation 1:

$$present\_value = {\sum }_{n = 0}^{T} \frac{{P}_{n}}{{( 1 + \frac{r}{12} )}^{n}} \qquad ( EQ . 1 )$$

where

r is the annual interest rate,

T is the term of the loan in months,

pₒ is an initial payment, and

pₙ is the loan payment for month n.

Since the payments for a conventional fixed rate loan are all the same and the present value of the conventional loan equals the borrowed principal, Equation 1 may be converted to Equation 2:

$$\begin{matrix}borrowed\_principle = \frac{P}{1 + \frac{r}{12}} + \frac{P}{{( 1 + \frac{r}{12} )}^{2}} + … + & ( EQ . 2 ) \\ \frac{P}{{( 1 + \frac{r}{12} )}^{n}} + … + \frac{P}{{( 1 + \frac{r}{12} )}^{T}} & \\ or & \\ P = borrowed\_principle \div & ( EQ . {2}^{′} ) \\ ( \frac{1}{1 + \frac{r}{12}} + \frac{1}{{( 1 + \frac{r}{12} )}^{2}} + … + \frac{1}{{( 1 + \frac{r}{12} )}^{n}} + … + \frac{1}{{( 1 + \frac{r}{12} )}^{T}} ) & \end{matrix}$$

where P is the monthly payment 4 for the conventional loan. It should be appreciated that analogous techniques may be used to form different types of conventional loans, such as a mortgage that is repaid bi-weekly.

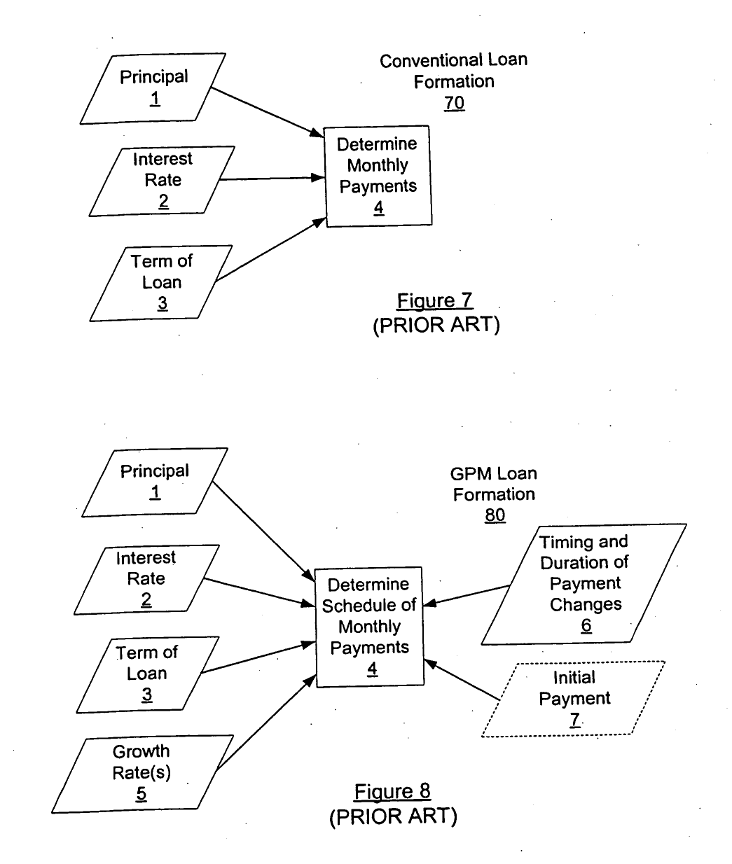

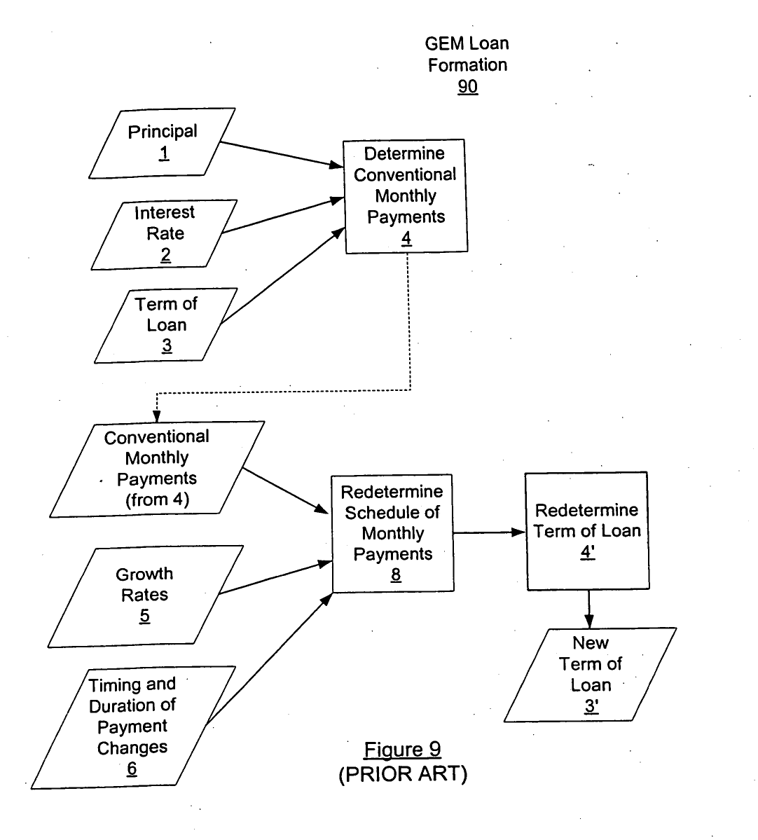

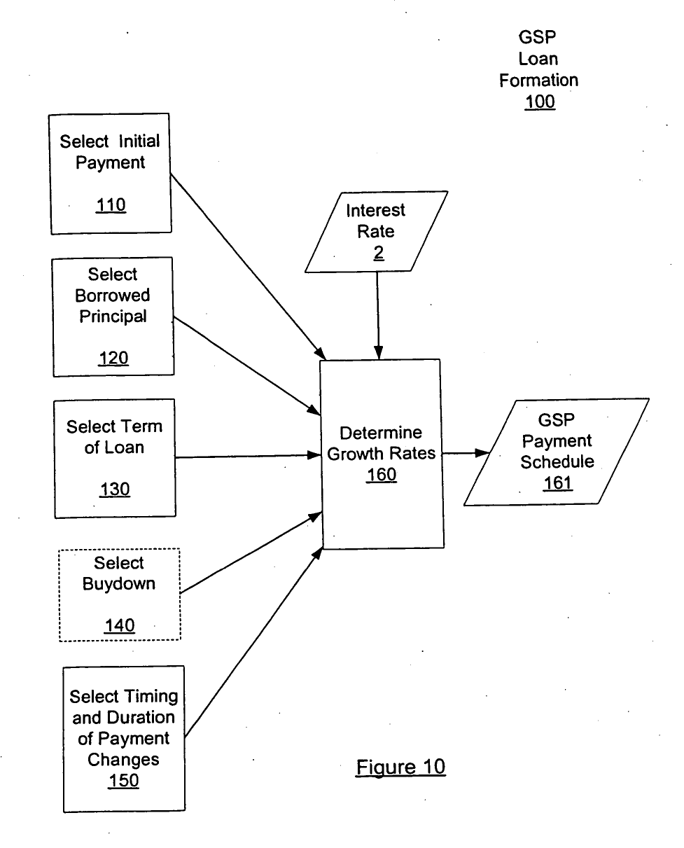

Turning now to FIG. 8, GPM loan formation 80 similarly entails using the borrowed principal 1, the interest rate of the loan 2, and the term of the loan 3, in conjunction with a desired growth rate 5 in the payments and the timing and duration of the payment changes 6. The GPM monthly payments can be calculated to achieve a present value equal to the borrowed principal 1, as described above in Equation 1. For instance, if a GPM loan increases annually by a growth rate g for the first 5 years of a loan and the payments are constant thereafter for a 30-year loan, then:

$$\begin{matrix}present\_value = [ {P}_{1} {\sum }_{n = 1}^{12} \frac{1}{{( 1 + \frac{r}{12} )}^{n}} ] + \\ [ {{P}_{1} ( 1 + g )}^{1} {\sum }_{n = 1}^{12} \frac{1}{{( 1 + \frac{r}{12} )}^{n}} \times \frac{1}{{( 1 + \frac{r}{12} )}^{12}} ] + \\ [ {{P}_{1} ( 1 + g )}^{2} {\sum }_{n = 1}^{12} \frac{1}{{( 1 + \frac{r}{12} )}^{n}} \times \frac{1}{{( 1 + \frac{r}{12} )}^{24}} ] + \\ [ {{P}_{1} ( 1 + g )}^{3} {\sum }_{n = 1}^{[ T ] 12} \frac{1}{{( 1 + \frac{r}{12} )}^{n}} \times \frac{1}{{( 1 + \frac{r}{12} )}^{36}} ] + \\ [ {{P}_{1} ( 1 + g )}^{4} {\sum }_{n = 1}^{12} \frac{1}{{( 1 + \frac{r}{12} )}^{n}} \times \frac{1}{{( 1 + \frac{r}{12} )}^{48}} ] + \\ [ {{P}_{1} ( 1 + g )}^{5} {\sum }_{n = 1}^{300} \frac{1}{{( 1 + \frac{r}{12} )}^{n}} \times \frac{1}{{( 1 + \frac{r}{12} )}^{60}} ] +\end{matrix} \qquad ( EQ . 3 )$$

where p₁, is the initial payment of the loan (and the payment for the first year).

For more information on the present value calculations of GPM loans, please refer to Brueggeman, Fisher & Stone, Real Estate Finance, 11^{th} Ed., McGraw-Hill/Irwin 2002, at pp. 138-39. The monthly payments for the GPM loans may be determined using equation 3 to solve for p₁. Such calculations may be easily performed using commercially available financial calculators or spreadsheet applications.

It should be appreciated that it is also possible to construct a mortgage with gradually stepped payments but without using a precise, multi-decimal growth rate that offers the same benefits as those embodied in the GSP loans discussed herein. For instance, beginning with a predetermined initial payment, one can select a growth rate in discreet increments of an ⅛ (or other fraction) of a percent for a specified number of payments. By multiplying the loan's monthly interest rate times the principal outstanding each successive month and allocating the difference between interest and each monthly payment as principal repaid, an amortization schedule can be established for the specified number of payments. The principal balance outstanding at the end of the schedule can then be amortized fully as a conventional constant payment at the loan's interest rate over the remaining term of the loan. Instead of a growth rate to the nearest ⅛ (or other fraction) of a percentage point, one could select discreet increments of basis points (or even fractions of basis points). The remaining balance could always be amortized over a series of constant final payments, or even a nominal final payment. In any event, no matter how the loan's payments are structured, as long as they step up for at least half its term at an annual growth rate less than 2% but not a full percent or half percent (or combination thereof), the end result will be a series of gradually stepped payments with the unique benefits of the GSP mortgage and therefore would be included within the scope of the present invention as described herein.

Continuing with FIG. 8, a specific initial payment 7 may optionally be specified as well in the calculations of the GPM payments. Then, Equation 1 (or other equivalent techniques for determining present value) could be used in step 4 to determine the schedule of GPM payments required to yield a present value equal to the borrowed principal 1.

Continuing with an analysis of known lending instruments, formation of the GEM loan 90, as depicted in FIG. 9, generally begins with the determination of monthly payments for an equivalent conventional loan, as described above in FIG. 7 and the accompanying text. In particular, the borrowed principal 1, the interest rate 2, and the length of the loan 3 are used in step 4 to determine conventional monthly payments. The conventional monthly payments from step 4 are then used with a growth rate 5 and the timing and duration of the changes 6 to determine a GEM payment schedule having a series of modified payments, step 8. By setting the present value to the borrowed principal and using the modified GEM payments schedule from step 8, Equation 1 may be used in step 4′ to redetermine the term of the loan 3′ by solving for T.

It should be appreciated that alternative methods are known for computing present value. These and newly developed methodologies for calculating present value may be used with the present invention without deviating from its intend scope.

Each one of the above-described loan formations (60, 70, and 80) entails solving for monthly payment amounts and/or loan term using present value calculations given various input factors including a predefined growth rate. The present invention provides a GSP loan that is formed using an alternative process. In particular, GSP loan formation 100, as depicted in FIG. 10, uses the initial monthly payment amount as an input value selected in step 110. Other steps in the GSP loan formation 100 include the selection of borrowed principal in step 120, selection of a loan length in step 130, and selection of the timing and duration of changes in monthly payments in step 150. The borrower may also optionally select a buydown amount in step 140. The data collected in these steps (110-150) and the interest rate 2 are then used to determine the growth rate by which the initial payment will change (in step 160) and, thus, define a GSP payment schedule for the duration of the loan. The calculation of the loan repayment amounts in step 160 typically uses Equation 1, or a variation thereof, to determine changes to the monthly payments so that the stream of payments has a present value equal to the borrowed principal.

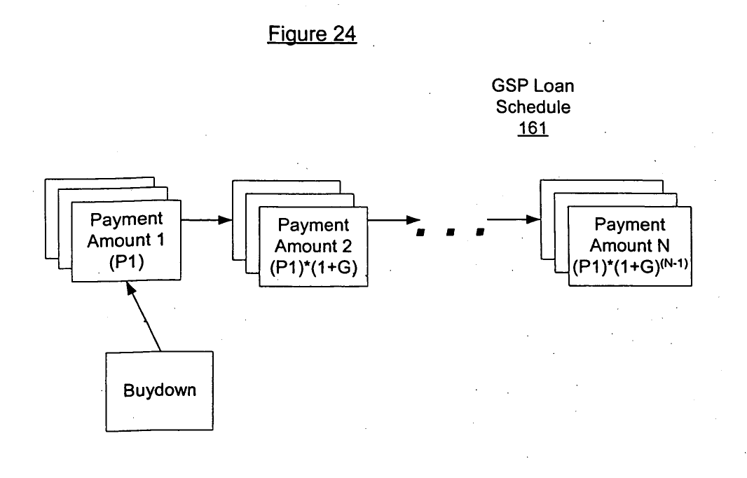

Overall, the GSP loan formation method 100 in FIG. 10 produces a GSP payment schedule 161, as illustrated in FIG. 24. The GSP payment schedule 161 has a series of payments defined by an initial payment amount p1 and a growth rate that is intermittently or periodically stepped by a growth rate G (a decimal increase). The payments continue to step until an Nth set of payments. For GSP loans that increase annually for the entire term of the loan, the Nth set of payments represents the last year of the loan. If the GSP payments level off during the term of the loan, prior to the end of the term, the Nth set of payments may cover a longer period. For example, a 30 year GSP loan having annually increasing payments for the first 20 years that stabilize thereafter would have a 21^{st} payment amount (equal to P1(1+G)²⁰) that would be in effect for the last ten years of the loan.

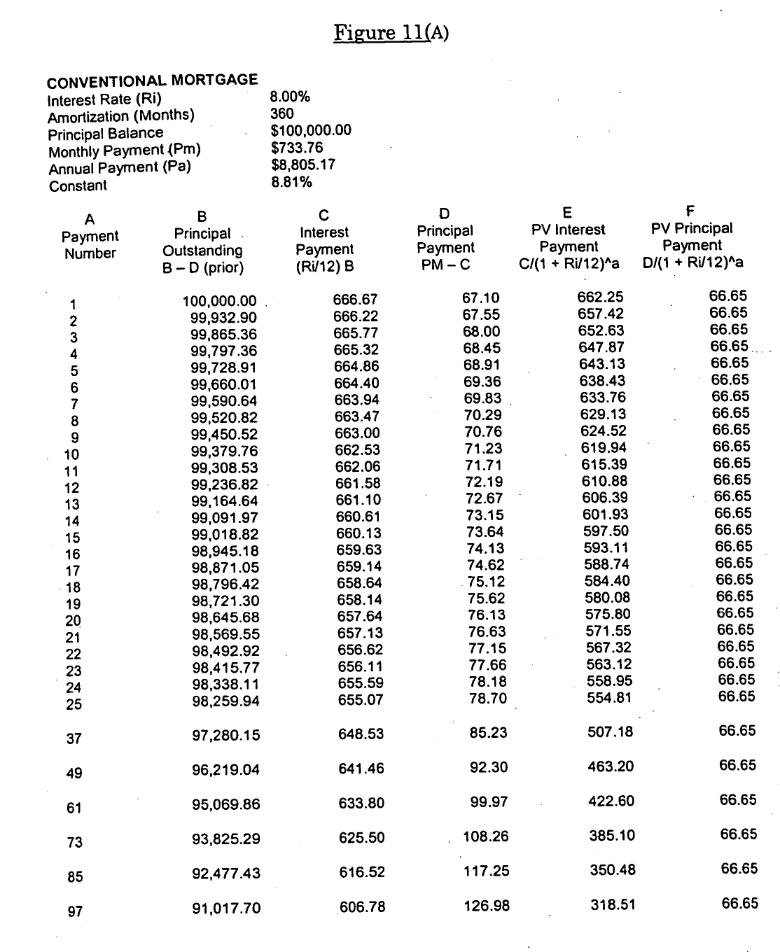

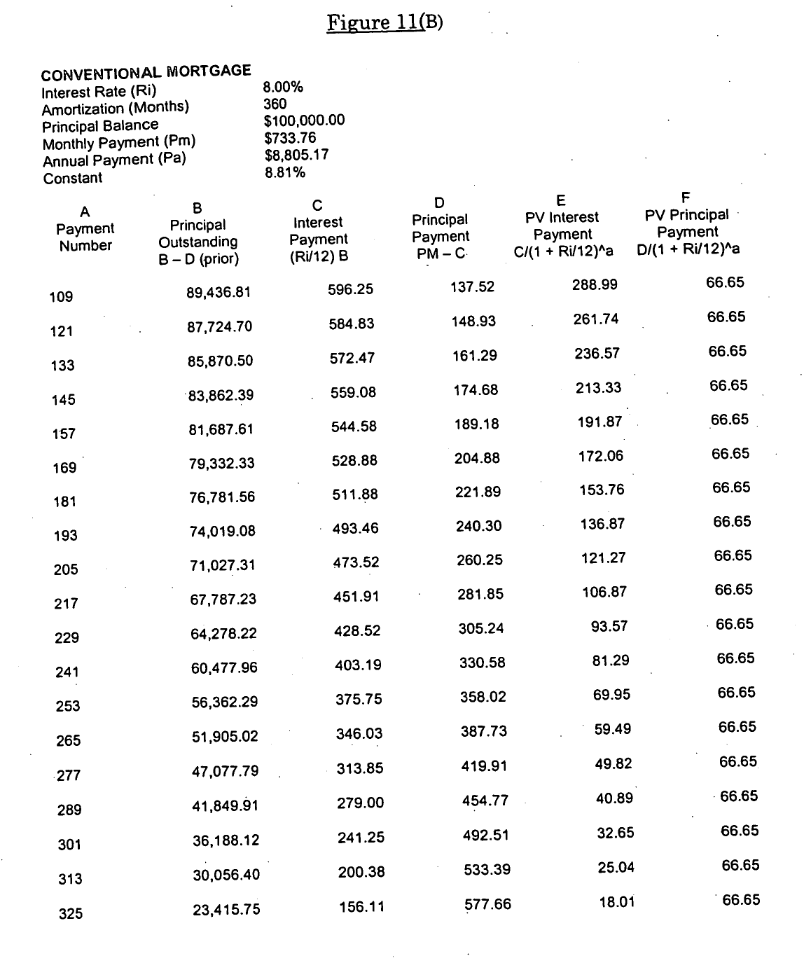

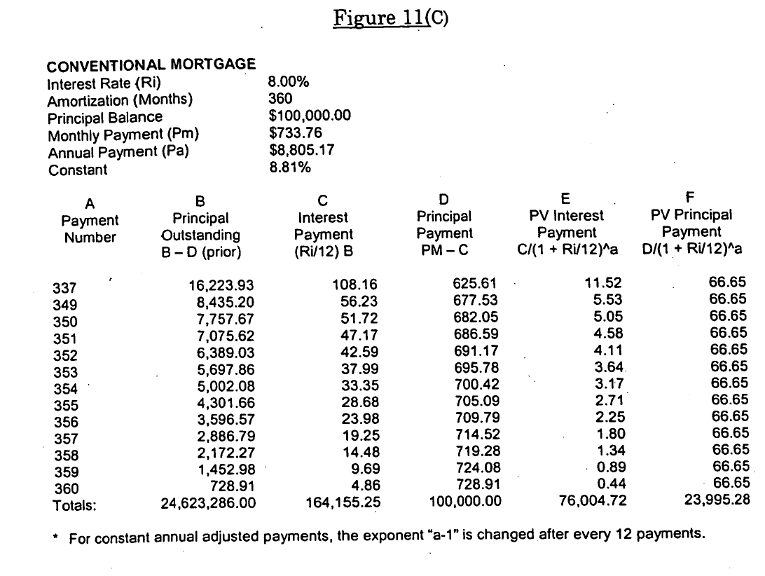

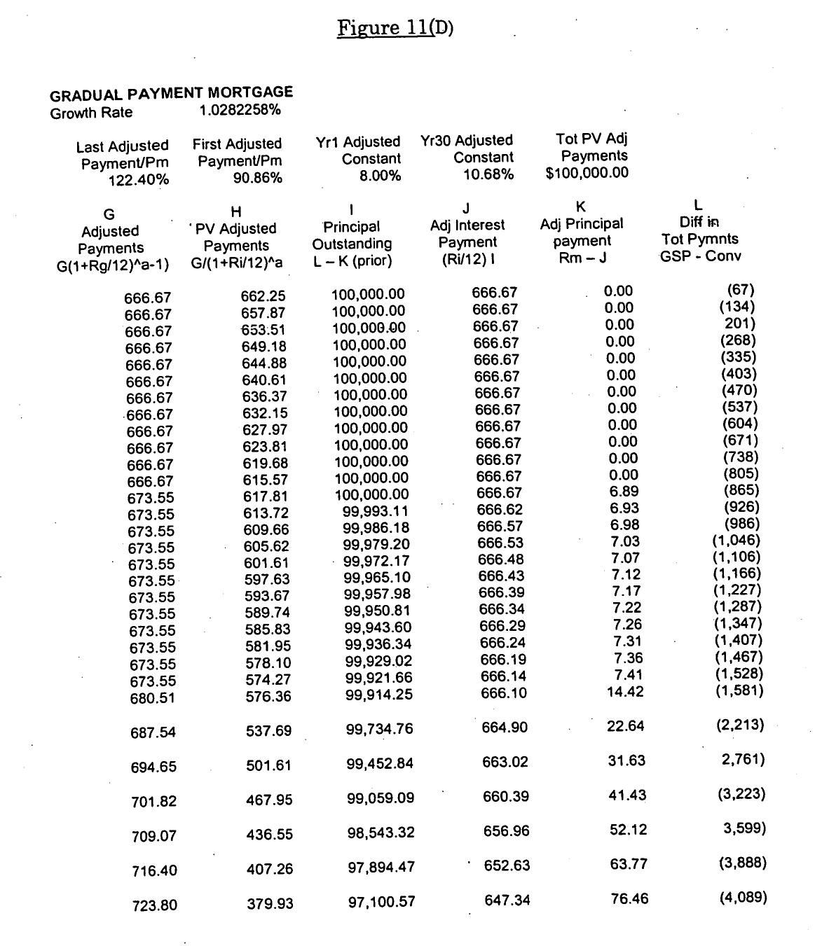

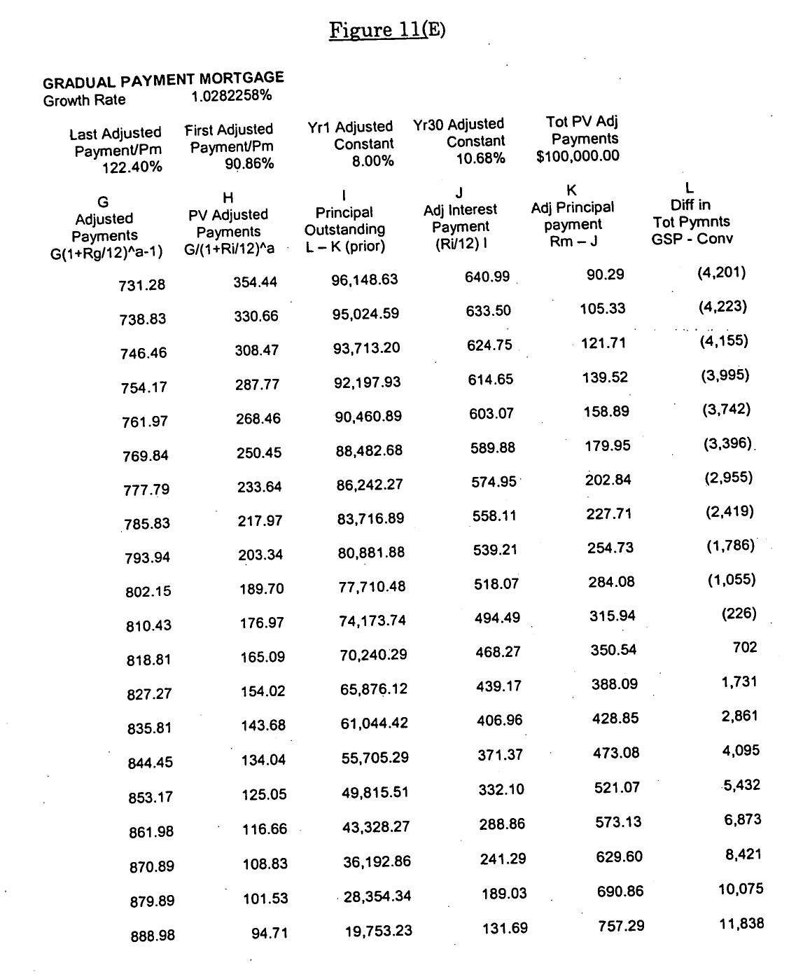

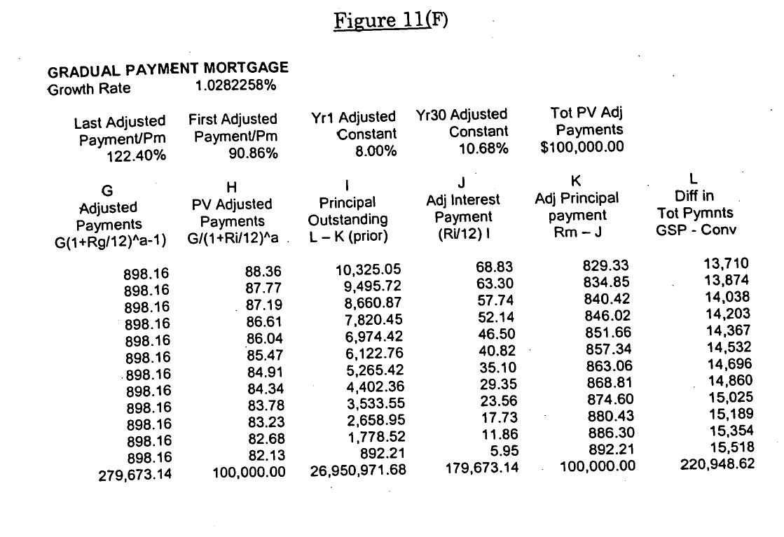

FIG. 11 shows how the present value (PV) of a conventional loan's constant payments equals the face amount of the loan itself. Specifically, the aggregate present value of the conventional loan's interest payments in column e plus the aggregate present value of the principal payments from column f equals its $100,000 loan balance.

Looking at the conventional mortgage detailed in columns a through f of FIG. 11, it can be seen how after multiplying the outstanding principal balance by 1/12th of the annual interest rate to calculate the interest due each month in column c, the amount of the constant payment “left over” in column d is the principal repaid by the sinking fund. The payments in column d constitute the sinking fund and total the principal balance of the loan. Each succeeding month's interest is charged against a principal balance that is reduced by the previous month's sinking fund payment until the last installment of principal is just enough to retire the remaining balance of the loan. In fact, as long as a series of payments has the same present value as a conventional mortgage, the same process of first calculating the interest due on the outstanding principal balance and then applying whatever is left over from the payment to reduce that balance will also result in paying off the loan with the last installment. This method of calculating payments of interest and principal is applicable to the stepped payments of GSP loans, as well. As can be seen from FIG. 11 and the examples that follow, it provides an alternative to the conventional sinking fund and amortizes a loan precisely. In addition, it will be seen that the present value of the GSP mortgage's interest payments combined with the present value of all its principal payments equals the original principal balance of the loan.

The example in FIG. 11 details the calculation of a GSP mortgage with a principal amount of $100,000, a repayment period of 30 years, and an interest rate of 8 percent. The lender first chooses a desired initial payment (in this case interest only at the 8% rate of the 30 year conventional mortgage used as a benchmark). Then the lender decides how frequently to change the payment (in this case once a year, every year). Next, using iteration or a present value formula, the lender determines the growth rate (Rg) by which these payments (listed as “adjusted payments” in column g) would step up over the term of 30 years. At the beginning of the second year and each year thereafter the first adjusted payment was increased (multiplied) by (1+Rg) compounded monthly. The present value of the resulting stepped payments is then calculated using the benchmark discount rate of 8% on a monthly basis. The succeeding columns of FIG. 11 show what portion of each stepped payment was interest and how much was principal. This was accomplished in column j by multiplying 8% divided by 12 (monthly interest) times the outstanding principal balance to calculate the interest owed for that payment. The difference between the interest owed and the total stepped payment shown in column k is the principal amount by which the loan balance is then reduced (or amortized) each month. Just like the conventional loan's sinking fund payment in column d, the sum of the GSP loan's principal payments in column k equals $100,000. Note how the last principal payment is exactly equal to the remaining principal balance of the loan. When compared to the conventional loan's sinking fund, column k shows how the gradually increasing payments of the GSP loan result in less amortization during the early years and more towards maturity. Since the total principal outstanding over the term of the GSP loan in column i is 9.45% greater than the total for the conventional loan, a borrower would pay 9.45% more total interest if the GSP loan is held to maturity.

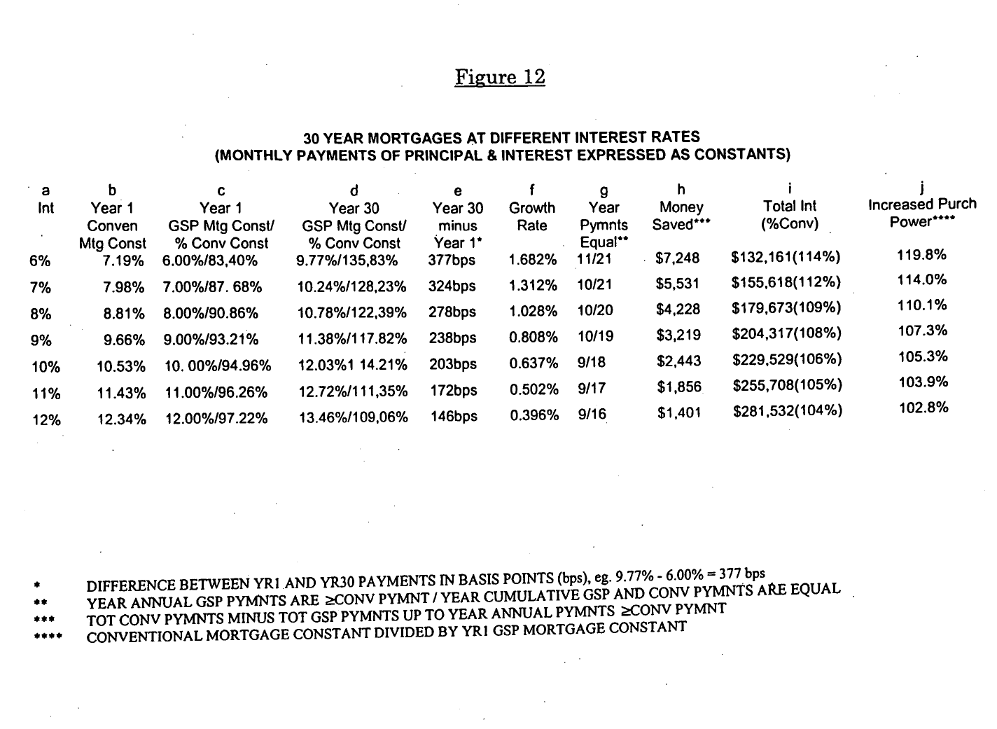

For purposes of comparison, FIG. 12 shows GSP mortgages that increase once every year with the first year's payment equal to the interest only payment at the coupon rate of the conventional loan. Also, this example considers mortgage “constants;” i.e., the total amount of interest and principal paid each year divided by the initial mortgage balance. Each constant is expressed as a percentage. FIG. 12 also shows how the initial and final payments of a 30-year GSP loan change as the interest rate on a comparable fixed payment conventional mortgage changes. It also shows how the growth rate must change in order to keep the present value of the GSP loan's payments equal to the present value of the corresponding conventional mortgage's payments.

Looking first at column b in FIG. 12 showing the conventional mortgage constant, note how the difference between the interest rate and the mortgage constant decreases as the interest rate in column a increases. This is a result of the sinking fund. As explained earlier, combining each month's payment of principal into the sinking fund with the corresponding interest payment results in the conventional loan's fixed payment. When annualized, the fixed payments divided by the original balance of the loan give us the mortgage constant. Since (i) each successive payment into the conventional loan's sinking fund increases by 1/12th of the mortgage's interest rate and (ii) the sum of the sinking fund payments equals the original balance of the mortgage, it stands to reason that the initial sinking fund payments must become progressively smaller as the interest rate increases. That is why the conventional mortgage constant is 1.19% (or 119 basis points) higher than the corresponding 6% interest rate but only 34 basis points (bps) higher at the 12% rate.

Continuing with FIG. 12, column c shows a constant equal to the interest rate because, to facilitate comparison, these GSP mortgages have been structured to make their first year's payments interest only. As the conventional loan's initial sinking fund payment decreases when interest rates rise, the gap narrows between the GSP loans' initial interest only payments and the conventional mortgage constant. This explains why the GSP loans' first year payments in column c become a progressively higher percentage of the conventional loans' constant payments as the interest rate increases. It also explains why the final year's payment shown in column d for the 30 year GSP mortgage becomes a progressively lower percentage of the conventional loans' payments as the interest rate increases. Again, it should be noted that to be amortized precisely, a GSP mortgage must have the same present value as a conventional mortgage of comparable term and rate. Consequently, the less of a shortfall there is between a GSP loan's early payments and the constant payments of a conventional mortgage, the less the GSP loan's later payments will have to exceed the conventional payments in order to keep the present value of the GSP mortgage equal to the conventional loan. Naturally, as the absolute difference between the GSP loans' first and last years' payments narrows in column e, the rate at which the payments have to grow each year must decrease as well. This in turn explains why the GSP loans' growth rates in column f decrease as the interest rate of the conventional mortgages increases.

Continuing with FIG. 12, column g illustrates how the gradually stepped payments of each GSP mortgage do not begin to exceed the fixed payment of a comparable conventional mortgage until after 9 to 11 years. Column g also shows which year the aggregate payments of principal and interest for GSP loans become as large as the cumulative payments of conventional 30 year mortgages. This ranges from 16 to 21 years depending on the interest rate. By then the conventional mortgages will have amortized 4.4% to 12.6% more than GSP loans charging 12% and 6%, respectively. Since most people hold onto a fixed rate 30 year mortgage less than 10 years, however, they may prefer a GSP loan whose low early payments can enable them to borrow or save more money instead of pay down their loans.

Returning to FIG. 12, column h shows how much borrowers can save before a GSP loan's payment equals or exceeds the constant payments of a conventional loan. The lower the interest rate, the bigger the near term savings. Conversely, column i shows how much more interest a borrower must pay for a GSP loan versus a conventional loan if held to maturity. Due to its lower early payments, a GSP loan amortizes more slowly, resulting in more cumulative principal outstanding over the life of the loan that earns more interest than a comparable conventional mortgage. Column i illustrates how the lower the interest rate, the higher the difference in total interest paid. This is because amortization of a GSP loan proceeds more slowly than a conventional mortgage as the interest rate decreases.

Continuing with FIG. 12, column j shows the additional purchasing power inherent in the lower initial payment of each GSP mortgage. Since the 7% GSP loan's first year payment is 87.7% of the conventional constant, for example, the additional purchasing power will be 1/0.877=114%. Considering that the growth rate is a modest 1.31% and payments increase only 324 bps over the life of the loan, using this GSP mortgage to obtain 14% more than they could get with a conventional fixed payment loan could be a pretty attractive opportunity for many borrowers. However, some borrowers and lenders may find the 20% greater purchasing power for the 6% mortgage a bit excessive and the 3% additional purchasing power for the 12% loan too small to consider. GSP mortgages often can also be structured to achieve the amount of additional purchasing power desired, as discussed in greater detail below.

The individual steps of the GSP loan formation 100 are now described in greater detail.

Determine Initial Monthly Payment 110

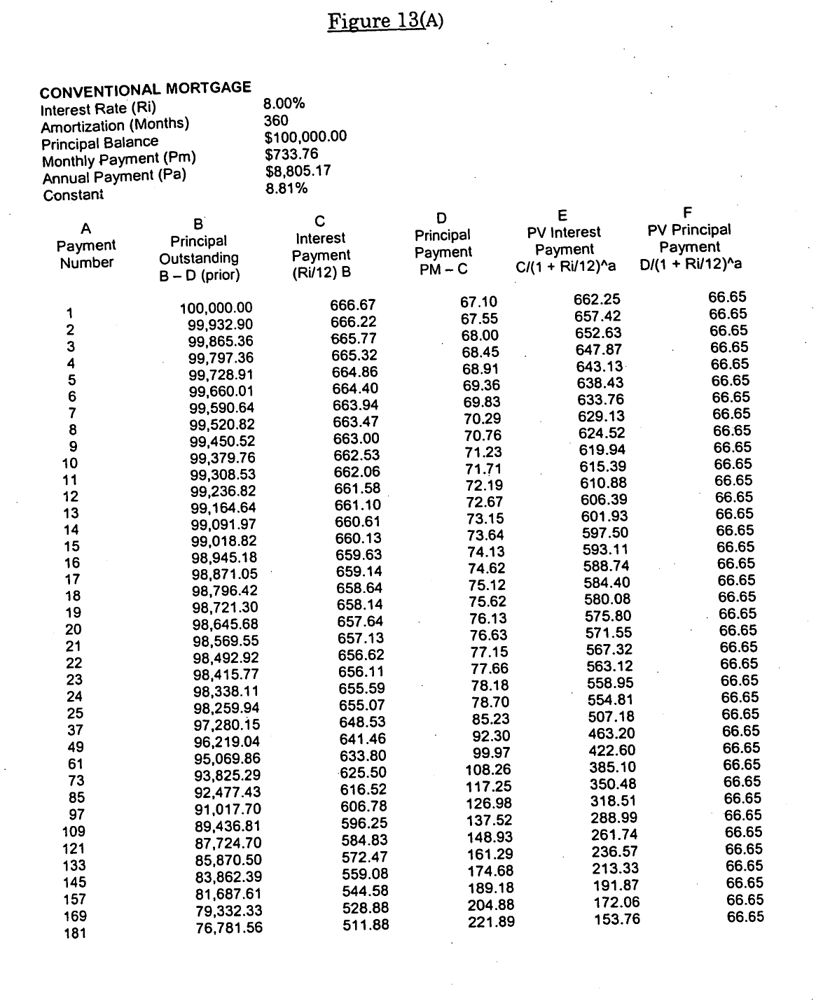

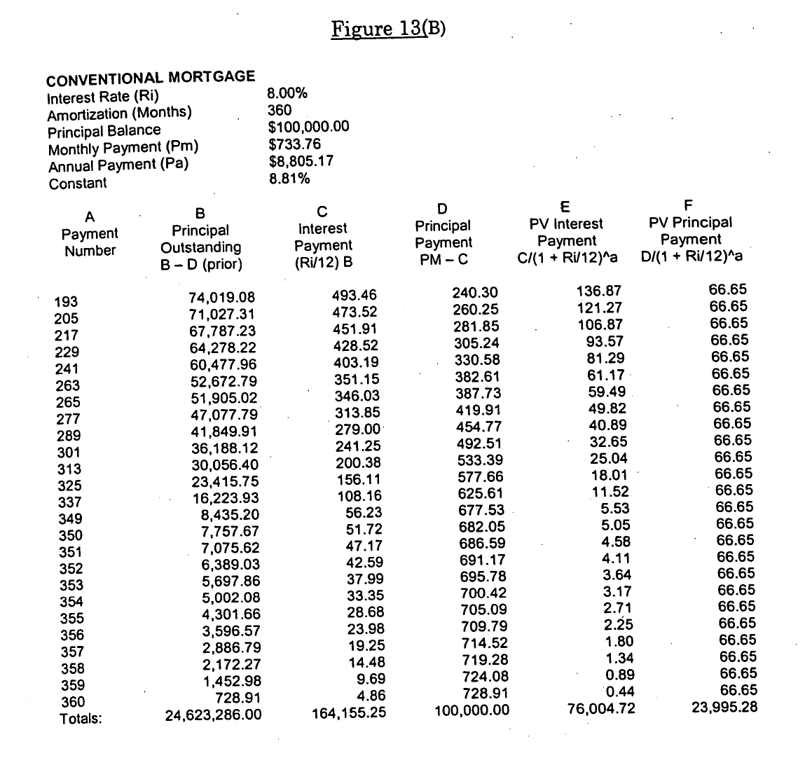

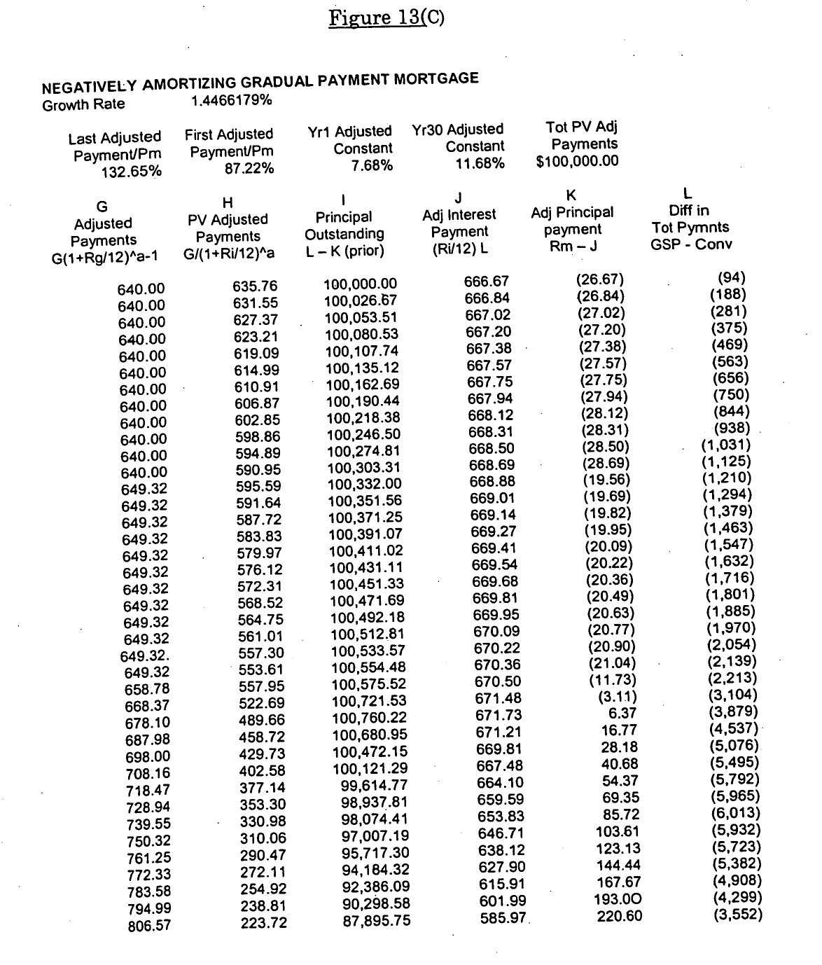

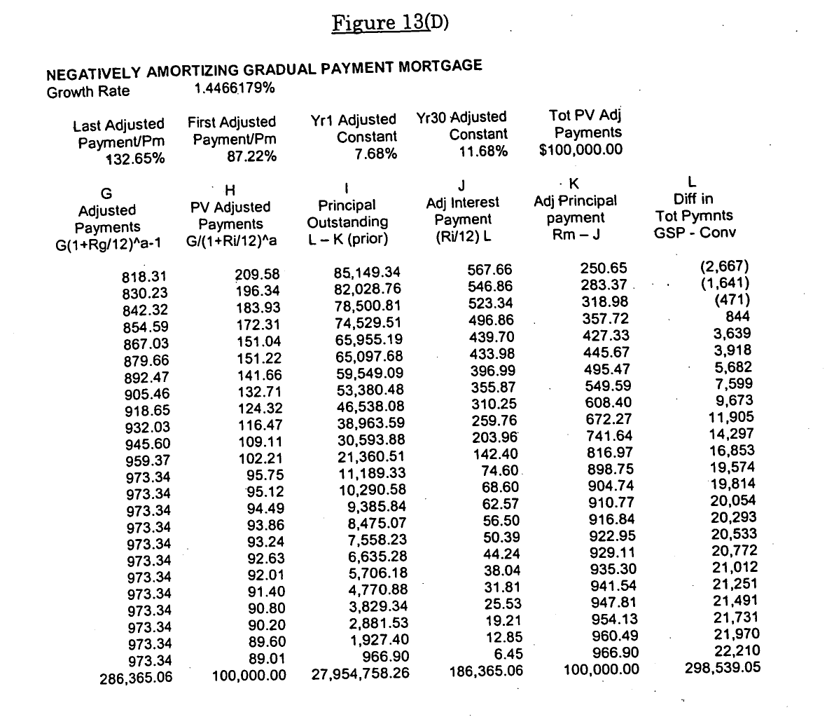

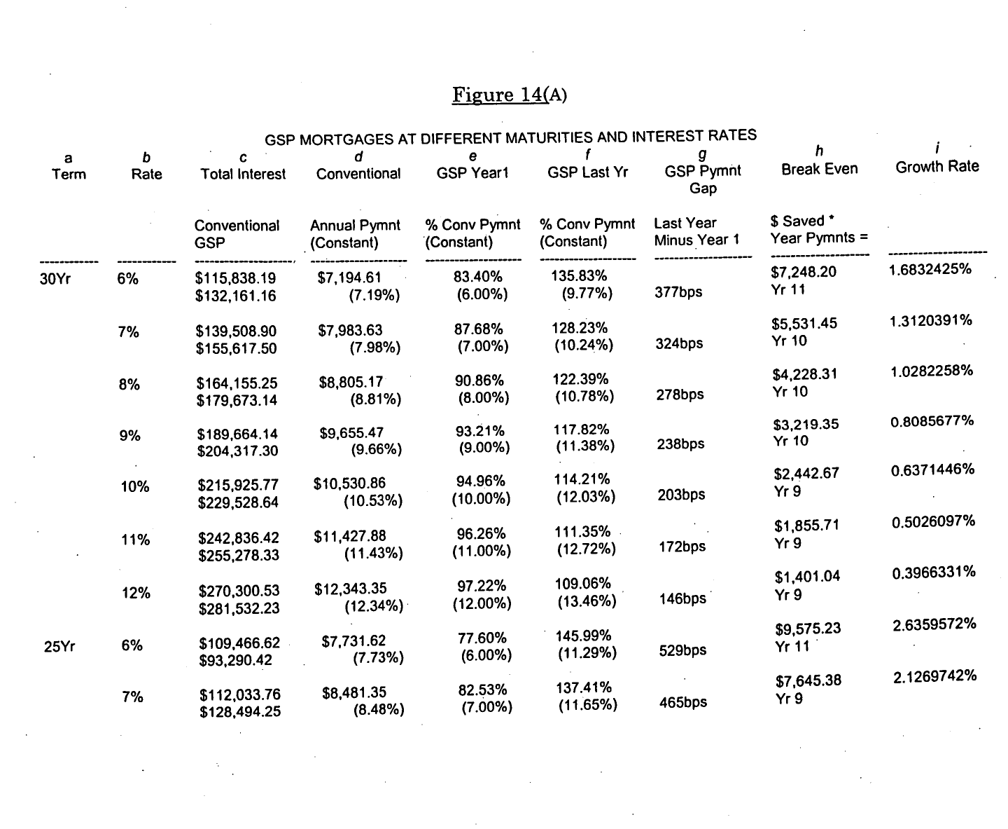

The initial payment of a GSP mortgage can be set at practically any amount desired. After selecting the initial payment, the growth rate of the succeeding payments can be adjusted to yield the same present value as a comparable conventional loan. The present application discusses monthly loan payments because that is the norm for conventional mortgages. However, there is no reason why a lender or borrower could not select quarterly or bi-annual payments, if desired. Secondly, the present application specifies a first year of interest-only payments to facilitate analysis of the GSP loans at different interest rates. Furthermore, the first payment is kept equal to the interest rate on the comparable conventional loan because to begin lower would result in “negative amortization.” It is believed that most borrowers and lenders would prefer to avoid negative amortization because it ends up increasing the size and, therefore, the risk of a loan. As shown below in FIG. 13, a GSP mortgage is started with payments less than the interest charged on the loan, the shortfalls in interest in column k must be added to the principal balance in column i as negative amortization. This results in a higher growth rate for payments, more principal outstanding and, therefore, more total interest paid over the term than the GSP loan detailed in FIG. 11.

As inferred from Equation 3, defining present value, the level of initial payments and the growth rate have an inverse relationship: the higher the growth rate, the lower will be the first year's payments required to achieve a given present value(and visa versa). Borrowers are likely to have several considerations that will influence the selection of the growth rate for a GSP mortgage. First, they will want initial payments low enough to give them the additional purchasing power or near-term savings they desire. Second, they will not want to have payments increase so much each year that they might outpace personal income. And, third, they will want to be comfortable with the magnitude of the change between the first and last years' payments. Thus, the selection of a first year's payment is a balancing act between a desire to minimize initial payments and need to ensure against an excessively aggressive growth rate (that may exceed a borrower's ability to pay).

As can be seen above in FIG. 12, in which column e shows the difference between the first and final years' payments, a growth rate of 1.68% or less results in final payments that are less than four full percentage points (400 bps) higher than the first year's payments. Four percentage points over 30 years is pretty tame when compared to ARMs, which may increase six full percentage points in just three years. Also, as long as the CPI exceeds their growth rates, the final payments for the 30-year GSP mortgages shown in FIG. 12 should be worth less than their initial payments in terms of inflation adjusted dollars. Still, payments rising from 6% to 9.77% over 30 years constitute a hefty 63% increase and, while perhaps too conservative, lenders and borrowers may more comfortable if the payments rose no more than 50% over a thirty year term. Moreover, lenders and borrowers would likely feel most comfortable with payments that do not increase much more than 1.5% a year over the loan term. That would be less then the recent CPI and limit the gap between the first and last years' payments to approximately 3 percentage points, which means the payments on a GSP mortgage would increase in 30 years little more than half as much as an adjustable rate loan could increase in just 3 years. Over time most borrowers' incomes could be expected to at least keep pace with that kind of increase in mortgage payments.

Overall, the foregoing considerations strongly suggest that a GSP mortgage whose payments grow about 1.5% or less each year presents little appreciable default risk. This means that a lender could qualify a borrower based on the GSP mortgage's first year payments as a percentage of the borrower's income. Take the case of the 8% GSP mortgage in FIG. 12. Its initial payment is approximately 91% of a conventional 30-year mortgage's payment. Based on this GSP loan's first year payment, a borrower could qualify for a loan that is 1/0.91=110% greater than possible with the conventional 30 year mortgage. To most lenders, that would be a competitive advantage, and to most borrowers, that is a lot more money. And, in the case of some lower income families, it could mean the difference between owning instead of renting a home.

In the same way, first year payments may be increased to lower the growth rate. FIG. 12 and the accompanying text discussed that the growth rates for GSP loans of 8% and above were approximately 1% or less, but that for the 6% and 7% GSP mortgages they were 1.68% and 1.31%, respectively. For lenders and borrowers uncomfortable with a growth rate much above 1%, a higher initial payment might be in order. Table 1 below compares the 30 year 6% and 7% GSP loans having first year payments interest only to GSP loans whose initial payments are higher and, therefore, include some principal. The higher payments are set at about 91% of the payments for comparable conventional loans so that they will have 10% additional purchasing power.

TABLE 1
30 YEAR CONVENTIONAL MORTGAGES FOR
$100,000 COMPARED TO GSP MORTGAGES WITh
DIFFERENT GROWTH RATES

| a | | c | d | E | f |
|---|---|---|---|---|---|
| Int | b | Total Int/ | Yr1/ | Added | Yrl Pymnt |
| Rate | Type | % Conv | % Conv | Purch Pwr | (as constant) |
| 6% | 30 Yr Conv | $115,838 | $7,195 | | |
| | 30 Yr GSP | $132,161/ | $6,000/83% | 20% | 6.00% |
| | | 114% | | | |
| | 30 Yr GSP | $124,404/ | $6,541/91% | 10% | 6.54% |
| | | 107% | | | |
| 7% | 30 Yr Conv | $139,509 | $7,984 | | |
| | 30 Yr GSP | $155,618/ | $7,000/88% | 14% | 7.00% |
| | | 112% | | | |
| | 30 Yr GSP | $151,166/ | $7,258/91% | 10% | 7.23% |
| | | 87% | | | |

| a | | G | H | i | j |
|---|---|---|---|---|---|
| Int | b | Difference | Yr Pymnts | Money | Growth |
| Rate | Type | Yr1 & Final | Equal* | Saved** | Rate |
| 6% | 30 Yr Conv | | | | |
| | 30 Yr GSP | 358 bps | 11/21 | $7.248 | 1.683% |
| | 30 Yr GSP | 196 bps | 11/21 | $3,780 | 0.905% |
| 7% | 30 Yr Conv | | | | |
| | 30 Yr GSP | 324 bps | 10/21 | $5,717 | 1.312% |
| | 30 Yr GSP | 233 bps | 11/21 | $4,021 | 0.962% |
| *Please note that the first entry in column h represents the years into the loan when the annual payments for GSP begin to exceed the annual payments | | | | | |
| # for a conventional loan, and the second entry in column h represents the years into the loan when the cumulative payments on the GSP begin to exceed the cumulative payments on the conventional loan. | | | | | |
| **Please note further that column i represents the difference between the total payments made on the GSP and the conventional loans, up to the year in | | | | | |
| # Column h that the annual GSP payment begins to exceed the annual convetional payments. | | | | | |

In order to achieve the 10% additional purchasing power the growth rate for the 6% GSP mortgage is a mere 0.905%. As a result, the 30th year's payment is only 1.96 percentage points higher than the first year's payment. At 7% the growth rate and difference between the first and last years' payments are slightly higher. In both cases the impact of the gradually stepped payments is so small that any incremental risks of prepayment or default would be negligible. At the same time, however, the loans still provide borrowers with a choice of considerable near term savings or increased purchasing power. Clearly, borrowers can achieve greater than 10% additional purchasing power at these low interest rates. If they want to borrow more, they have to be comfortable with the tradeoff between additional proceeds and the growth rate necessary to achieve those proceeds.

The preceding section focused on making sure a GSP mortgage's payments don't grow too rapidly. However, GSP mortgages face a different concern when interest rates are higher. Since the differential between the fixed payments of a conventional 30 year mortgage and the initial interest only payments of a GSP loan becomes progressively smaller as interest rates rise, GSP mortgages with higher interest rates will have progressively less advantage in purchasing power based on their first year payments.

FIG. 12, above, indicates that the differential between the initial payments of 30 year GSP and conventional loans is 16+ percentage points at a rate of 6% but far less at 10% or higher. Some borrowers still might prefer the 10% GSP mortgage simply because its initial payments start 5% less than the conventional loan, reduce payments by $2,443 until they reach the conventional payment in year 10, and step very gradually to a final payment only 2 percentage points higher than its first year. Alternatively, it can enable people to borrow approximately 5% more for the same first year payment as a fixed rate conventional loan. Though such modest advantages should be attractive to some borrowers, in general, it is believed that the higher the interest rate, the fewer relative advantages 30 year GSP mortgages will have versus conventional loans. Nevertheless, GSP loans may be structured to offer substantial savings at higher interest rates and shorter maturities.

Determine Borrowed Principal 120

At the outset, the borrower and lender would designate a desired loan amount in step 120. Furthermore, as described in greater detail in other steps of the GSP formation 100, such as the discussion of the buydown in step 140, they may select inputs in the GSP loan formation 100 to achieve a larger desired principal balance.

Determine Loan Length 130

In order to evaluate how changing maturity affects GSP mortgages, the following discussion uses a constant 8% interest rate and considers a range of maturities from 15 to 30 years. For purposes of comparison, this discussion further assumes that a GSP mortgage's payments rise once a year, every year to maturity and that the first year's payments are interest only.

TABLE 2
15 TO 30 YEAR MORTGAGES @8% WITH
MONTHLY PAYMENTS OF PRINCIPAL AND
INTEREST EXPRESSED AS CONSTANTS

| | | c | d |
|---|---|---|---|
| | B | Year 1 | Last Year |
| a | Conven | GSP Mtg Const | GSP Mtg Const |
| Int | Mtg Const | (% Conv Const) | (% Conv Const) |
| 30 yrs | 8.81% | 8.00% (90.86%) | 10.78% (122.39%) |
| 25 yrs | 9.26% | 8.00% (86.38%) | 12.10% (130.67%) |
| 20 yrs | 10.24% | 8.00% (79.70%) | 14.30% (142.46%) |
| 15 yrs | 11.47% | 8.00% (69.76%) | 18.33% (159.82%) |
| E | | g | |
| Last Year | f | Year Pymnts | h |
| minus | Growth | Are Equal | Money |
| Year 1 | Rate | (Annual/Cum)* | Saved** |
| 278 bps | 1.0282258% | 10/20 | $4,228 |
| 411 bps | 1.7270555% | 10/18 | $6,051 |
| 630 bps | 3.0624258% | 9/16 | $8,892 |
| 1033 bps | 5.9357187% | 8/13 | $12,866 |
| *Please note that the first entry in column g represents the years into the loan when the annual payments for GSP begin to exceed the annual payments | | | |
| # for a conventional loan, and the second entry in column g represents the years into the loan when the cumulative payments on the GSP begin to exceed the cumulative payments on the conventional loan. | | | |
| **Please note further that column h represents the difference between the total payments made on the GSP and the conventional loans, up to the year in column g that | | | |
| # the annual GSP payment begins to exceed the annual conventional payments. | | | |

As shown in Table 2, the conventional mortgage's sinking fund has even more impact on loans with different maturities than it does for the loans of equal maturity but different interest rates that were detailed in FIG. 12. Column b of Table 2 shows how shortening the term causes the conventional mortgage's constant to rise dramatically. This is simply because there are fewer principal payments that can be added together to total the initial principal balance of the mortgage. Remember that the sum of a sinking fund's payments equals the amount of the loan. So it stands to reason that the fewer payments there are, the larger each payment must be to total the same loan amount. The shorter the term, the higher will be the conventional mortgage constant and the greater the shortfall between the GSP mortgage's initial interest only payments versus the fixed conventional payments of principal and interest. As the term decreases and this shortfall widens between the initial GSP payment in column c and the conventional mortgage constant in b, column e shows that the gap between the GSP mortgage's first and last years' payments widens as well. As explained earlier, this is necessary in order for the GSP, mortgage to have a present value equal to its conventional counterpart. Naturally, the wider the gap between the first and last payments, the higher must be the growth rate in column f to enable the interim payments to increase sufficiently to bridge the gap.

Not surprisingly, column g in Table 2 illustrates how the time by which the GSP mortgage payments break even with comparable conventional loans decreases as the term of the loans is shortened. Conversely, column h shows how the near term savings actually increase at the shorter maturities. This is attributable to the widening shortfall between the initial GSP payments and constant conventional payments as maturity is reduced.

While at lower interest rates GSP mortgages offer borrowers the advantage of significant near term savings or increased purchasing power, at higher interest rates this advantage is replaced by the potential to offer borrowers affordable shorter term loans with substantial savings in interest.

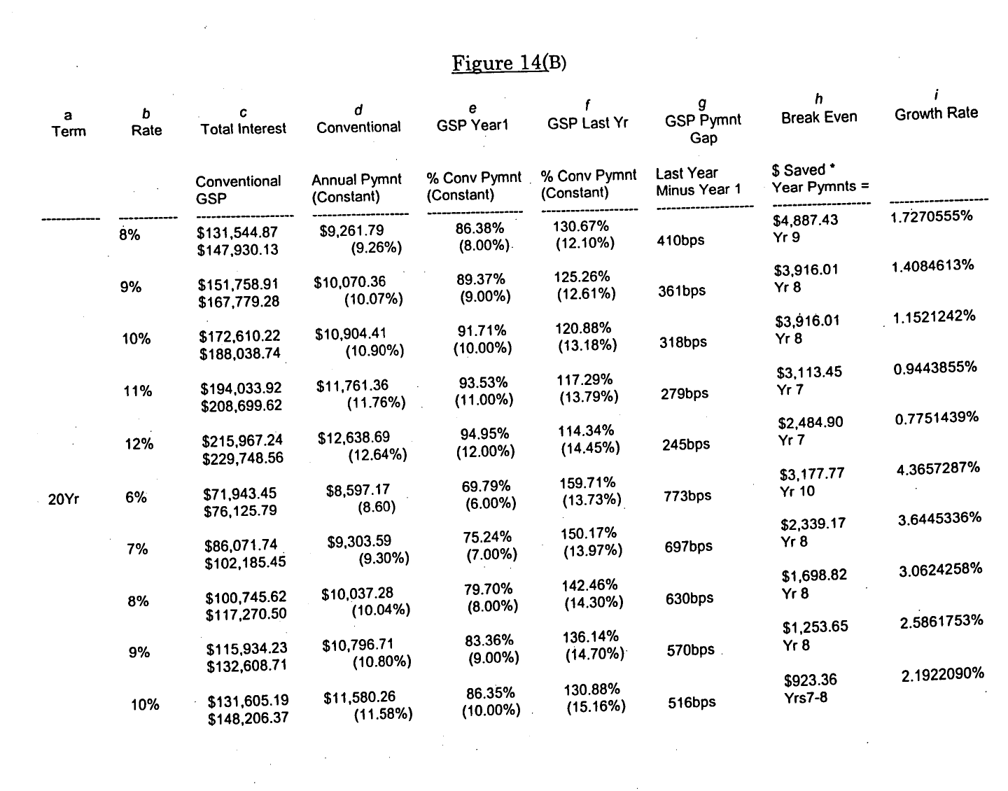

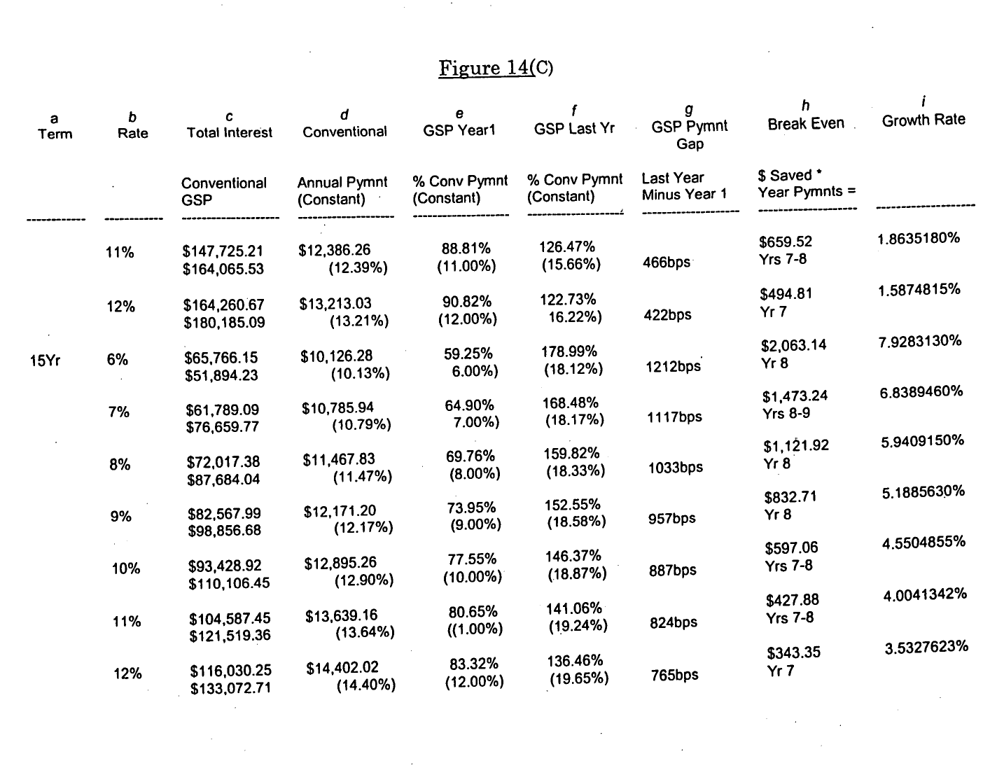

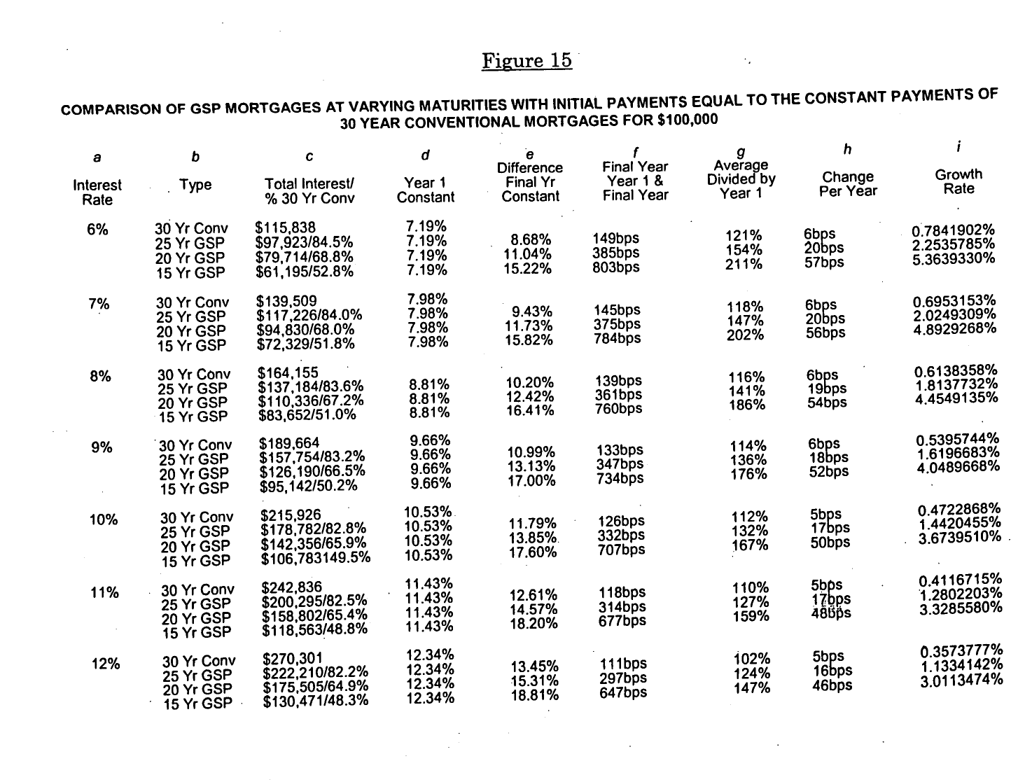

FIG. 14 illustrates the impact of changing the maturity for GSP mortgages at various interest rates. As can be seen from column c of FIG. 14, the primary benefit of a shorter term mortgage is the reduction of total interest paid over the life of a loan. For both conventional and GSP mortgages, total interest over the term of a 15 year loan is less than half that of a 30 year loan at the same interest rate.

Again, to facilitate comparison, all first year payments for the GSP mortgages in FIG. 14 are interest only. Column g shows the difference between the first and last years' payments, and column i showing the growth rate. At 15 years both the growth rate and the gap between the first and last years' payments are too extreme for most borrowers regardless of the interest rate. At 20 years the gap between the first year of interest only and the final year's payments on a 6% GSP mortgage is 773 bps (7.73 percentage points) and the growth rate to bridge that gap is 4.36% per year. Both measures are too high for a conservative borrower or lender, but they improve at higher interest rates. At 12% the gap between the first and last year's payments is 422 bps and the growth rate is 1.586%—numbers that may be acceptable to some borrowers and lenders.

At a 25 year term things start to become more manageable for these GSP loans with first year payments interest only. For a 25 year 6% GSP mortgage the gap between the first and last years' payments is a hefty 529 bps and the growth rate is still a considerable 2.64%. However, at 10% the gap in payments narrows to 318 bps and the growth rate is only 1.15%. At a 12% interest rate they are a mere 245 bps and 0.77%, respectively. The 25 year 10% GSP mortgage offers some attractive features: its initial payment is 5% less than a 30 year conventional fixed payment loan; it is repaid 5 years earlier; and it costs the borrower $27,887 (13%) less total interest than the 30 year conventional loan. At a 12% rate the 25 year GSP mortgage's initial payment is only 2.78% less due to the narrow differential between the 30 year conventional loan's constant and the interest paid during the first year; however, the total interest saved versus a 30 year conventional mortgage is $40,552 (15%). To summarize, FIG. 14 illustrates how the higher the initial interest rate and longer the maturity, the smaller will be the gap between the first and last years' payments of a GSP mortgage; however, just as with a conventional mortgage, borrowers will pay less interest over the life of a shorter term GSP loan.

A family that cannot afford more than the fixed payments on a 30 year conventional mortgage but wants to, repay its loan sooner might be more comfortable with a shorter term GSP mortgage with an initial payment the same as a comparable conventional loan. FIG. 15 illustrates GSP loans at 15, 20 and 25 year terms whose initial payments equal the fixed payments of conventional 30 year mortgages.

Looking first at a 15 year term, the gap between first and last years' payments in column f in FIG. 15, the average annual change in payments shown in column h and the annual growth rates in column i all seem too high. But at 20 years these parameters become more affordable, especially for GSP mortgages at higher interest rates. At 12%, for example, the growth rate is only 1.13% and the payments rise just 16 bps a year for a gap of only 297 bps between the first and last years. Even at a 6% interest rate the 385 bps gap between first and last years' payments and the 20 bps annual increase may be considered manageable for some borrowers, although the growth rate of 2.25% over a 20 year term might seem be too high for many. When compared to an ARM whose payments can rise a full 6 percentage points (600 bps) in 3 years, 385 bps over 20 years seems relatively tame; however, borrowers may also want to view the loan within the context of the first year's payment. At a 6% rate, the 385 bps increase above the first year's constant means their payments would rise 54% over the life of the loan. Some borrowers may not be confident that their incomes will keep pace with such changes. On the other hand, at a 12% rate the 2.97 percentage point increase means that over 20 years the payments would rise only 24% above the initial 12.34% first year constant. This would appear to be very manageable for most borrowers.

At a 25 year term, column c of FIG. 15 shows that, depending on their interest rate, borrowers could save anywhere from 1-84.5%=15.5% total interest for a 6% GSP loan to 1-82.2%=17.8% in total interest for a 12% GSP loan versus their 30 year conventional counterparts. Annual growth rates range from 0.357% to 0.784% and the difference between first and last year payments ranges from a mere 111 bps to 149 bps at interest rates of 12% and 6%, respectively. To place things in perspective, the 0.784% increase over the 6% mortgage's first year payment would be a mere $56 (or less than $5 more each month for a loan of $100,000). Since the growth rates and the difference between the first and last years' payments are so small, it would appear that many borrowers would prefer a 25 year GSP mortgage to a 30 year conventional loan whose initial payments were the same. It would be a relatively painless way of paying down their loans faster and saving interest in the process.

Another possible GSP mortgage uses year 1 payments set below 30-year conventional payments. By shortening the loan term, appropriate growth rates may be determined using the above-described present value techniques to a GSP payment schedule. The resulting a GSP loan has the advantages of a lower initial payment and a shorter loan term.

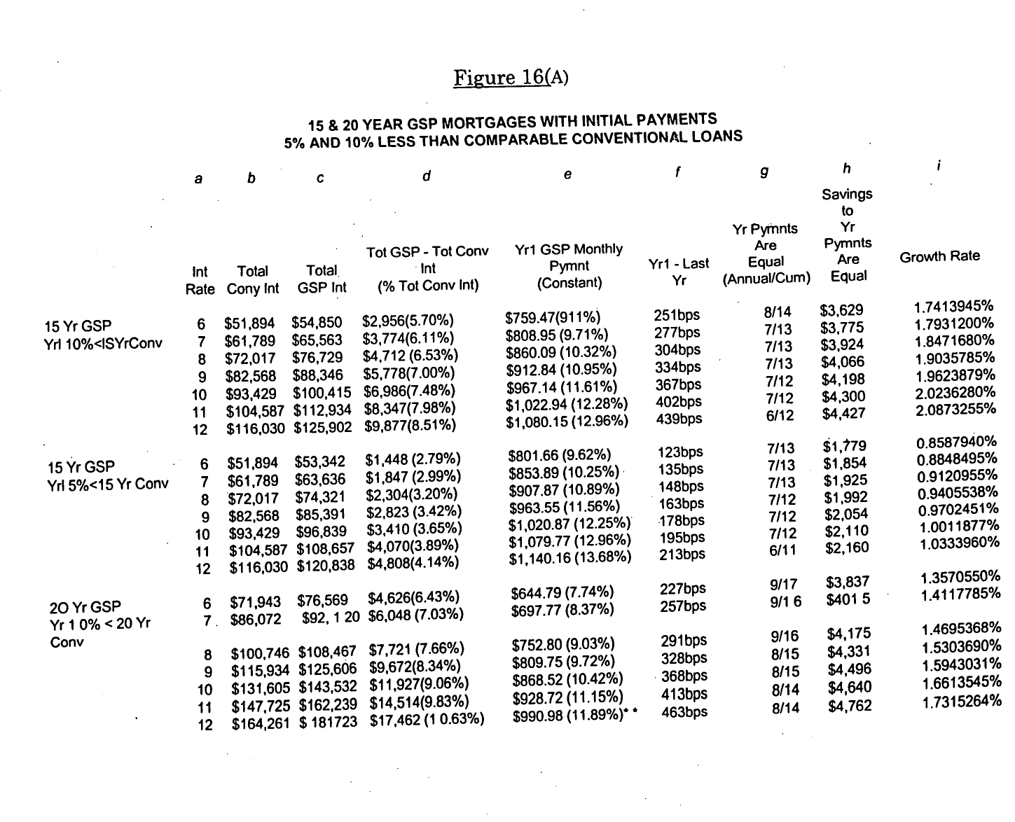

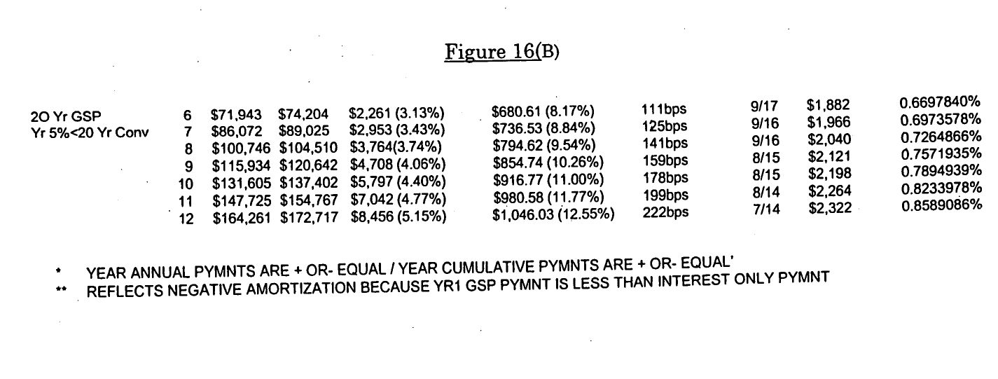

For example, one possible GSP loan may have a payment period of 15-20 Years where year 1 payments are 5%-10% below comparable conventional loans. As seen above, setting GSP mortgages' payments equal to the constant payments of 30-year conventional loans resulted in unmanageably high growth rates and gaps between the first and last years' payments for the 15-year loans. Of course, higher initial payments may reduce those gaps. This is demonstrated in FIG. 16, which details the structure of 15 and 20 year GSP mortgages with initial payments set 5% or 10% below the constant payments of conventional loans with the same interest rate and maturity.

Looking first at the 15 year loans in FIG. 15, the growth rates seem pretty high for the GSP loans with initial payments 10% less than the comparable 15 year conventional mortgages. However, the gaps between the first and last year payments shown in column f appear to be quite manageable at the lower interest rates. For example, the gap at 6% is 251 bps, which represents an increase of only 28% above the first year's payment. As a result, the 1.74% growth rate might be tolerable for many borrowers. This is even more compelling since the $3,629 in near term savings in column h actually exceeds the $2,956 additional interest (shown in column d) borrowers would pay over the term of the GSP loan. At higher interest rates the near term savings of these 15 year GSP loans become progressively less than the additional interest paid over the term of the loans but are nevertheless substantial. This leads one to conclude that some borrowers may opt for the near term savings afforded by these 15 year loans at higher interest rates despite the higher growth rates and gaps between the first and last years' payments.

It should be noted that lower initial payments on a GSP mortgage can translate into additional purchasing power. As long as some borrowers view the growth rates and gaps between the initial and final payments as acceptable, they might want to use these 15 year GSP loans to borrow up to 10% more than they could with a conventional 15 year fixed payment mortgage. This would be an aggressive way to maximize loan proceeds and then pay them off over a relatively short time frame.

Moving down FIG. 16 to the GSP loans with payments 5% less than comparable 15 year conventional mortgages, it is clear that the growth rates and gaps between first and last years' payments are modest at any of the interest rates shown. These GSP loans would be a convenient way of either achieving some near term savings or borrowing 5% more proceeds than a conventional 15 year loan while adhering to the discipline of repaying the loans over a short term.

Looking at the 20 year GSP loans in FIG. 16, the gaps between first and last years' payments range from slightly less than their 15 year GSP counterparts at lower interest rates to slightly more at higher interest rates. In addition, column d shows that the excess in total GSP interest over total conventional interest for loans at any given interest rate is more pronounced at the 20 year maturity. Regardless, in all cases the 20 year loans' growth rates are well below their 15 year counterparts, and the near term savings are slightly higher at 20 years. Therefore, whether they are interested in additional proceeds or near term savings versus a conventional fixed payment loan of the same maturity, more borrowers should be able to afford these 20 year GSP loans than the 15 year GSP loans.

To this point, whenever comparing GSP loans of different maturities the interest rate was kept constant regardless of a loan's maturity. In reality, interest rates are likely have an upward sloping yield curve that results in 15-year mortgages having a coupon 20 bps to 50 bps less than a 30 year mortgage, which means that a 20 year loan also will have a coupon less than a 30 year mortgage. For GSP loans with initial payments equal to 30 year conventional mortgages FIG. 15, above, showed that the growth rate and the gap between the first and last years' payments were too high at 15 year maturities but quite workable for a 20 year term. It has been found that when 20-year GSP mortgages carry an interest rate approximately 20 bps or more below 30 year conventional loans, the differential can yield tangible benefits to the structure of the GSP loans.

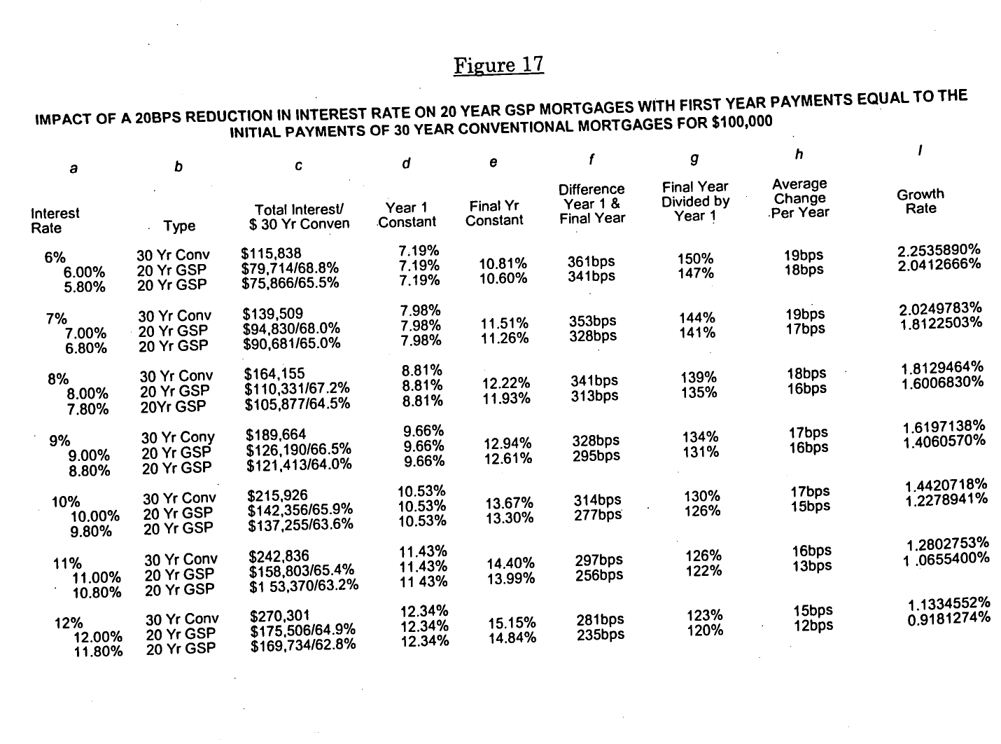

FIG. 17 illustrates the impact of reducing the coupon for 20-year GSP loans 20 bps below the coupon for 30-year conventional mortgages. By lowering the interest rate without reducing the initial payment, more principal is amortized in the early years of a loan. As a result, FIG. 17 shows how the lower rate GSP loan has a growth rate less than the 20 year GSP loan whose coupon remains 20 bps higher. The marginal benefit of the 20 bps reduction is substantial: a 20 bps/600 bps=3.3% reduction of the 6% coupon results in a 1-2.041%/2.253%=9.4% reduction in growth rate. And the benefit is even more pronounced at higher interest rates: a 20 bps/1200 bps=1.66% reduction of the 12% coupon results in a 19.0% reduction in growth rate. The positive tradeoff between interest rate and growth rate is due to the interest credited to each monthly payment of principal at the coupon of the loan. The higher that coupon, the more interest will be earned on each payment and the lower will be the growth rate required for the aggregate principal payments to equal the initial loan balance.

FIG. 17 further demonstrates how an upward sloping yield curve can make 20-year GSP loans more attractive to borrowers. The 20 bps reduction in rate for these shorter maturity loans results in both a lower growth rate and smaller gap between the first and last years' payments at every interest rate shown. More specifically, columns f and i. clearly illustrate how these benefits improve as the interest rate, of the loan gets higher. Most notably, the reduction in the gap between the first and last years' payments is 20 bps (5.5%) at the 5.8% rate and grows to 46 bps (16.4%) for the loan with an 11.8% coupon. These benefits would make it easier for borrowers to use a 20-year GSP loan to save interest and repay their debt faster without having to make a first year payment higher than the constant on a conventional 30-year mortgage.

Determine Buydown 140

One way of enhancing the purchasing power of GSP mortgages but avoiding negative amortization is through buydowns. For simplicity, the following discussion assumes that borrowers want a GSP mortgage for $100,000 that will enable them to qualify for a loan 10% larger than they could get with a comparable conventional 30-year mortgage. If the interest rate is 10%, the GSP loan's first year payment would have to be $9,583, which is 91% of the conventional 10% loan's fixed payment of $10,531 and yields 10% more purchasing power ($10,531/$9,583=110%). However, $9,583 is almost 4% less than if the GSP mortgage's first year payments were 10% interest only (i.e., $10,000), and any interest payments below 10% would result in negative amortization. Most borrowers and lenders would likely prefer not to have the balances of their loans increase. Borrowers can get around the problem of negative amortization by paying a fee to “buy down” the initial interest payments at the time the loan is made.

The following section discusses how to engineer a buydown of a 10%,thirty year GSP mortgage's annual payments that will enable a borrower to qualify for a loan that is 10% larger than he or she could get with a comparable conventional mortgage. While there are many ways to look at a buydown, one can begin by asking how much a GSP mortgage's payments can increase the first few years without outpacing a borrower's likely increases in income. Anything higher would risk making a lender reluctant to use the first year of a loans' stepped annual payments to determine how much it can lend. To be conservative, two criteria are proposed: first, annual steps should be less than or equal to the Consumer Price Index (CPI) and; second, the total increase over the term of the buydown should not be much more than one percentage point. The following example starts with a 2% growth rate for the buydown.

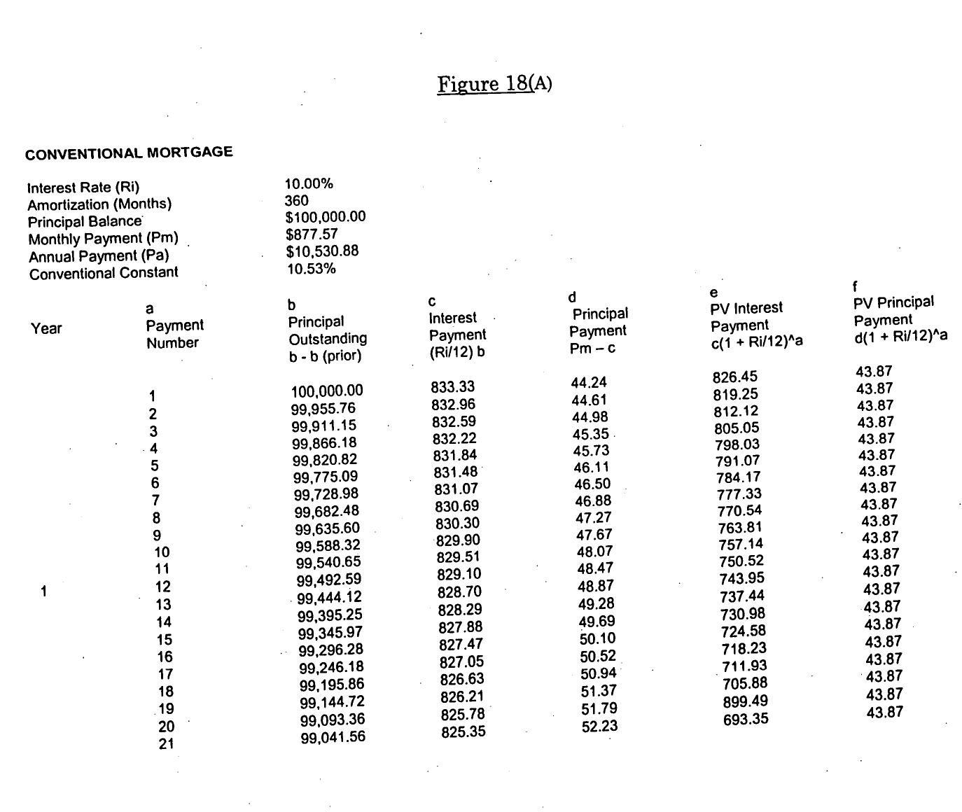

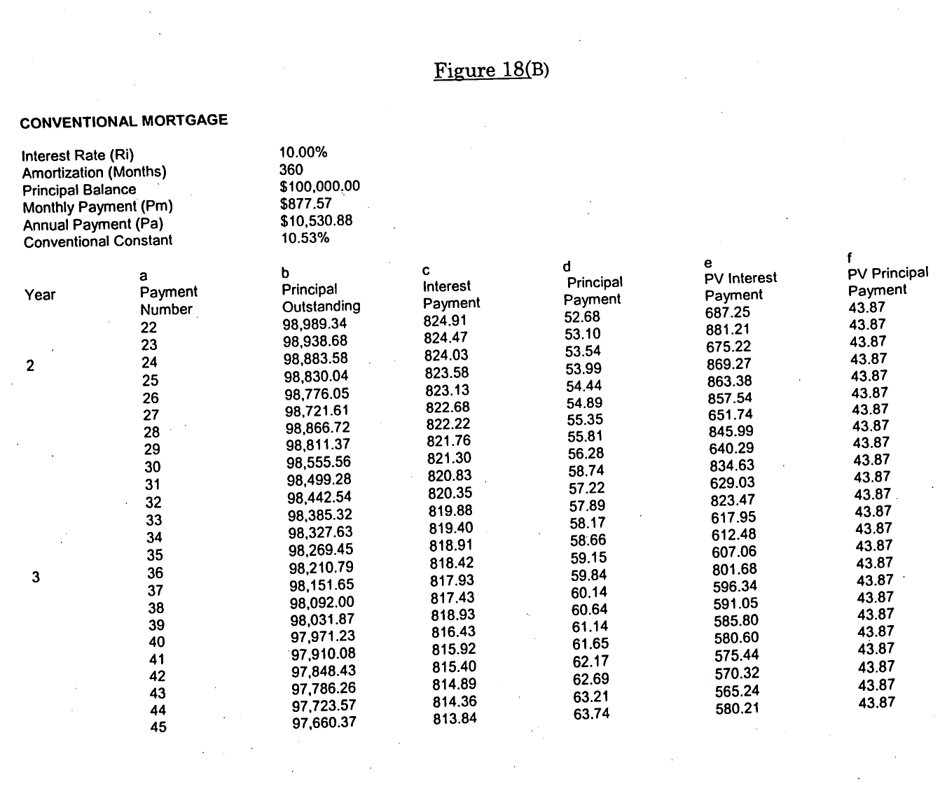

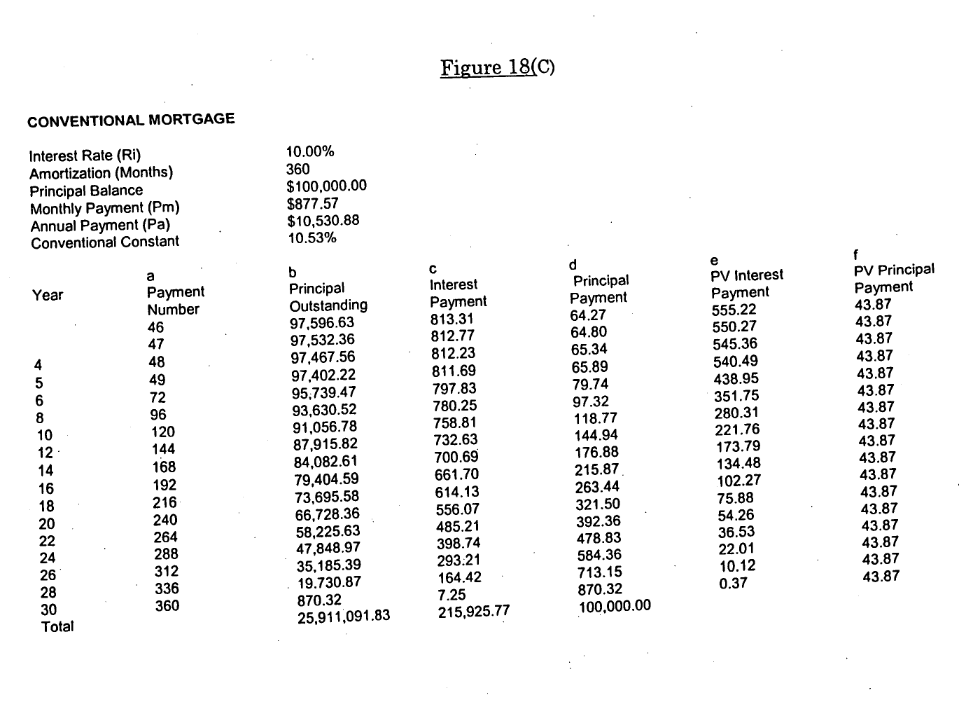

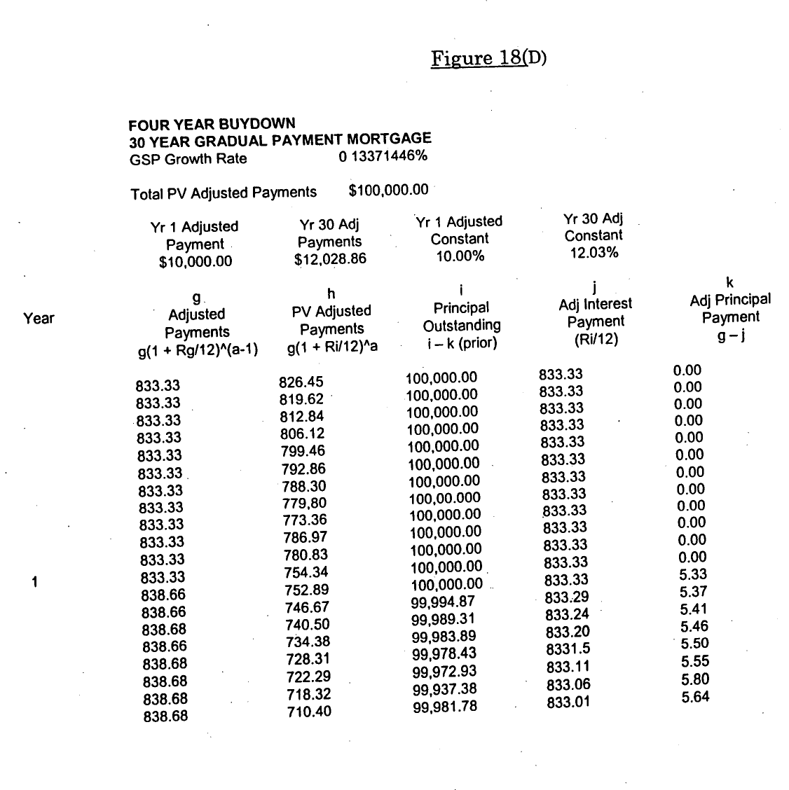

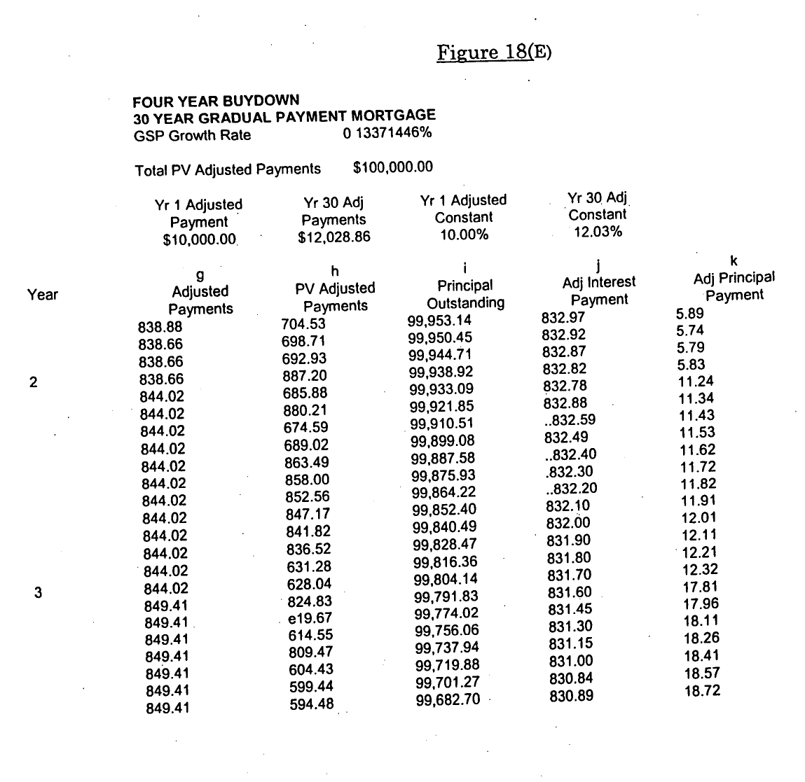

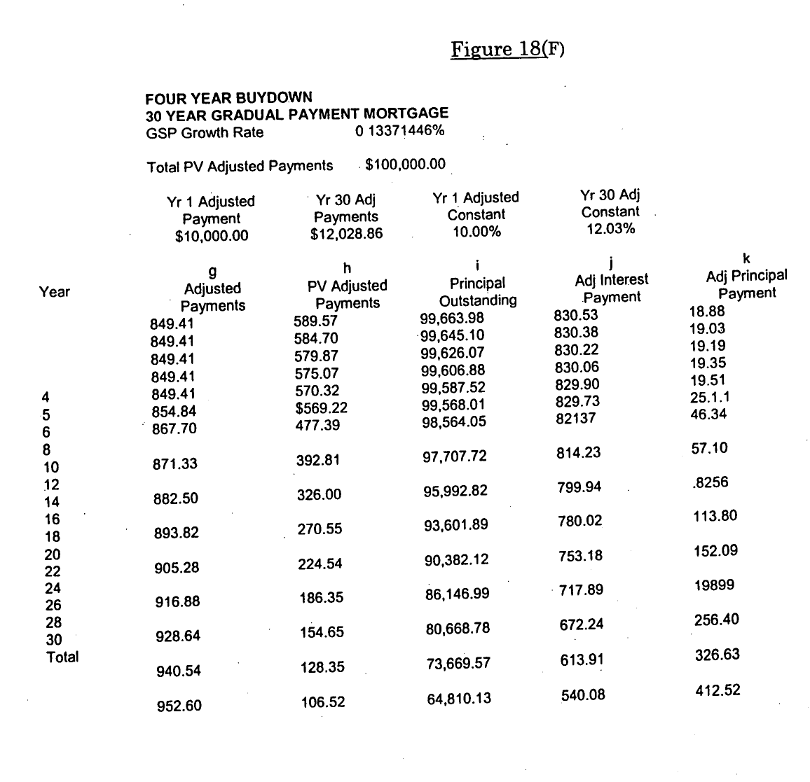

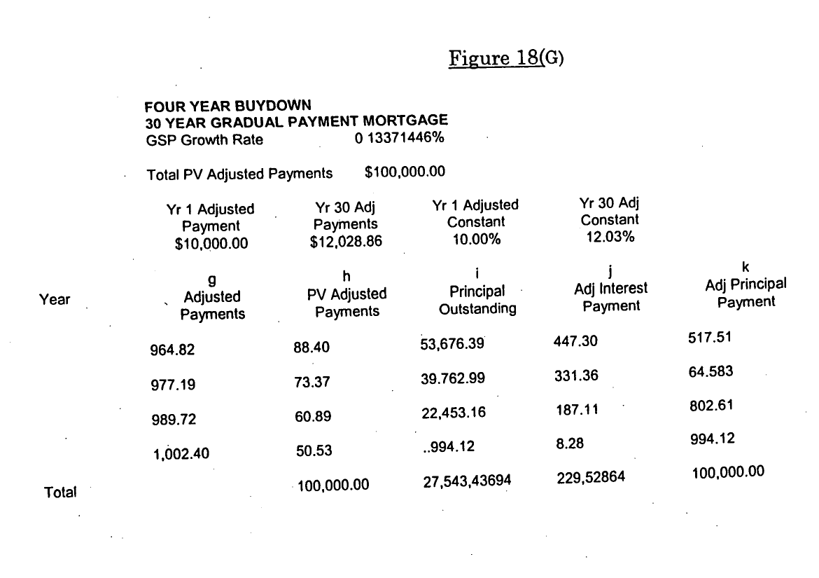

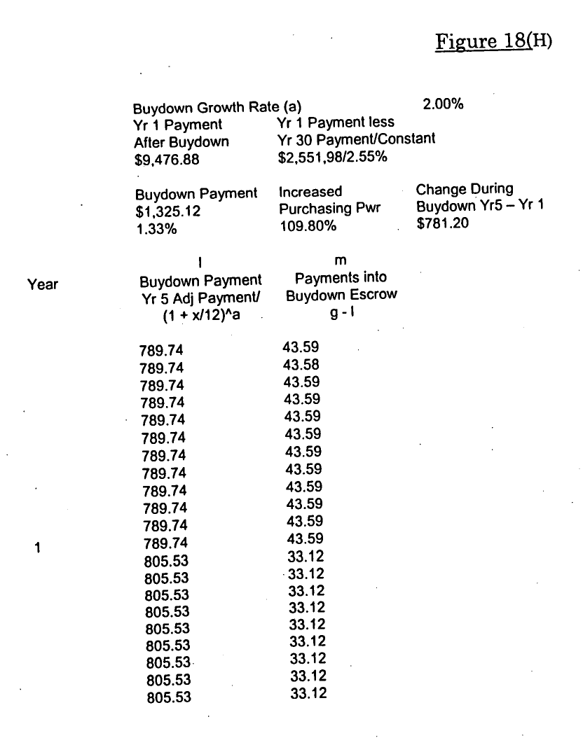

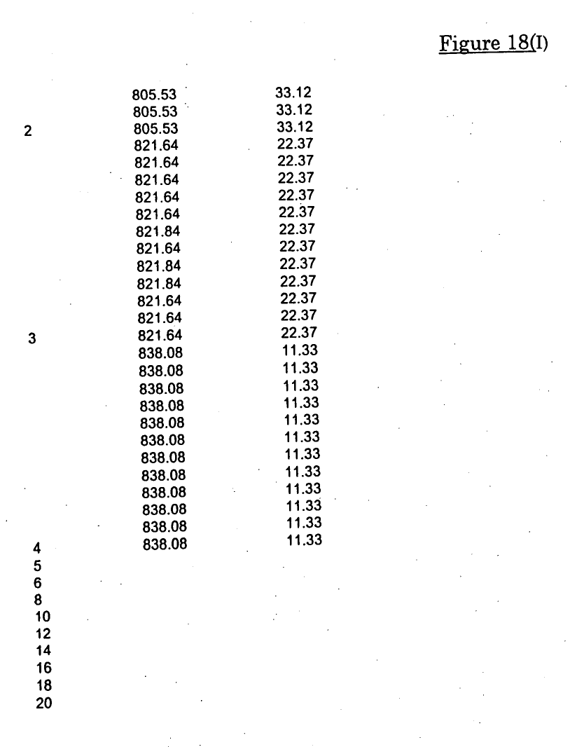

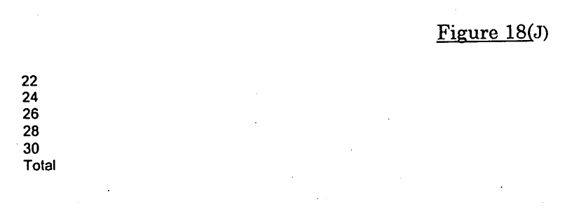

First, a GSP mortgage is calculated in FIG. 18 having the same present value as a 10% conventional 30 year loan. This results in a GSP mortgage with a 0.6371446% annual growth rate and a first year payment of $10,000 interest only. As discussed above, however, a first year payment is about $9,583, which is 91% of the conventional mortgage's $10,531 fixed annual payment of interest and principal. The GSP mortgage's stepped annual payments may be evaluated by using the 2% buydown growth rate and discounting (i.e., determining the present value) each payment back to the start of the loan to see which discounted payment would come closest to the target first year payment of $9,583. In this case the fourth year's $849.41 payment discounted three years using the 2% growth rate resulted in a first year payment of $9,605. This is a little higher than the desired level of $9,583, so the fifth year's payment may be discounted, which will result, instead, in a four-year buydown. As shown in column l of FIG. 18, discounting the fifth year's $854.84 adjusted monthly payment by the 2% buydown growth rate results in an initial buydown payment of $789.74 per month, which gives an annual payment of $9,476.88. To reiterate, most lenders scrutinize borrowers' incomes to determine the maximum amount that can be allocated to make the annual payments on a new mortgage loan. This analysis assumes that the lower initial GSP payments allow a person to borrow more. In this example, if a family could borrow up to $100,000 making a fixed annual payment of $9,476.88 on a conventional loan, then they could afford to borrow $111,122 based on the $10,530.86 first year payment of the GSP mortgage ($10,530.86/$9,476.88×$100,000=$111,121.59). This translates to 111.12% additional purchasing power if the family can afford the cost of the buydown.

The present invention employs a straight-forward approach to calculating the cost of the buydown. As detailed in FIG. 18, first the shortfall between each payment on the GSP mortgage before (column g) and after (column l) was discounted by the 2% buydown growth rate is determined. In this example, totaling the shortfalls in column m over the four years of the buydown equals $1,325.12, which equates to 132.5 bps on the initial $100,000 principal balance. This amount may be placed into an escrow, just as a mortgage lender would escrow for real estate taxes and pay the holder of the mortgage each month's shortfall in addition to the reduced payments made by the borrower. This way the holder of the mortgage would receive the monthly payments of interest and principal (columns j and k) scheduled for the “normal” GSP loan and thereby avoid the need for negative amortization. The 132.5 bps cost for the buydown is a fee to be paid by the borrower and therefore deducted from this GSP mortgage's 11.112% additional purchasing power. Therefore, the net incremental purchasing power for this GSP mortgage would be 111.12%-1.325%=9.80% (rounded). Regardless, borrowers are used to paying “points” for a mortgage and are unlikely to resist paying a buydown fee as “points” for a GSP loan that enables them to borrow more money.

Please note that the borrower makes the payments corresponding to the values in column l of FIG. 18 during the buydown and payments corresponding to column g thereafter. Accordingly, the holder of the mortgage would receive the payments in column g subsidized from the buydown escrow during years 1-4. Thus, the initial payment was bought down from $10,000 to $9,476.88 and then increased by 2% each year to the fifth year payment of $10,258.08. This is an increase of $781.20 over the four-year period from year one to year five, representing just 0.78% of the $100,000 loan balance. That is much less than the 2-percentage point increase one could have in one year with an ARM loan. Moreover, the difference between the first year's $9,476.88 payment and the final year's $12,028.86 payment is $2,551.98, just 2.55% of the initial $100,000 loan balance. That is an average increase of only $88 a year (less than a 1% average growth in each year's payments). Since payments on the bought-down GSP mortgage would increase little more over the 30 years than an ARM could in one year, there would be minimal default risk on the GSP mortgage. Therefore, lenders could reasonably use the first year's payment on the bought down GSP mortgage to determine how large a mortgage it could offer to a prospective borrower. If a borrower wanted a precise 10% net increase in purchasing power, the growth rate for the buydown would have to be raised from 2% to 2.06%. This would mean the borrower's payments still would increase less than one percentage point during the first four years. Moreover, the average annual increase over the 30-year term would remain just $88 (or 0.88% of the initial loan balance).

The prececeeding example in FIG. 18 and the associated text illustrated the basic mechanics of constructing a buydown but, to keep things simple, did not address some practical considerations that may concern borrowers. For instance, the family may borrow the buydown amount. If a family wants a GSP mortgage in order to maximize the amount of money it can borrow, it will most likely need to borrow the amount of the buydown fee, as well. The balance of the GSP mortgage can be increased accordingly.

Also, if the buydown fee is to be held in escrow for a few years, most borrowers would want to earn interest on the escrowed funds. By crediting the borrower all interest earned on the escrow, the lender can reduce the fee by the amount of interest it can be expected to earn.

Furthermore, some people may be reluctant to borrow a GSP mortgage that would charge more total interest over its term than a comparable conventional mortgage. For instance, it was described above that a GSP mortgage will charge more interest to maturity than a comparable conventional mortgage because it amortizes more slowly and, therefore, has on average a larger outstanding principal balance. By shortening the term of the GSP mortgage slightly, however, the total interest paid over its term may be approximately equal to the total interest of the conventional loan. Shorter terms require higher growth rates, however, and since most borrowers will not keep their loans to maturity, they may skip this refinement in favor of a slightly lower growth rate.

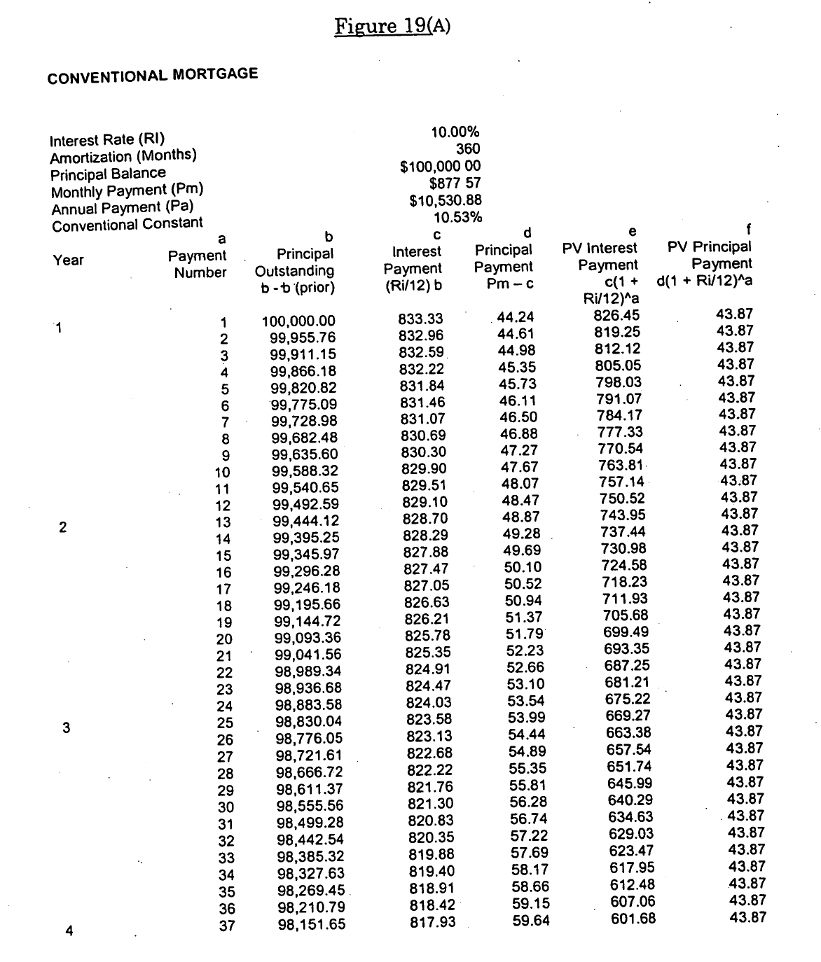

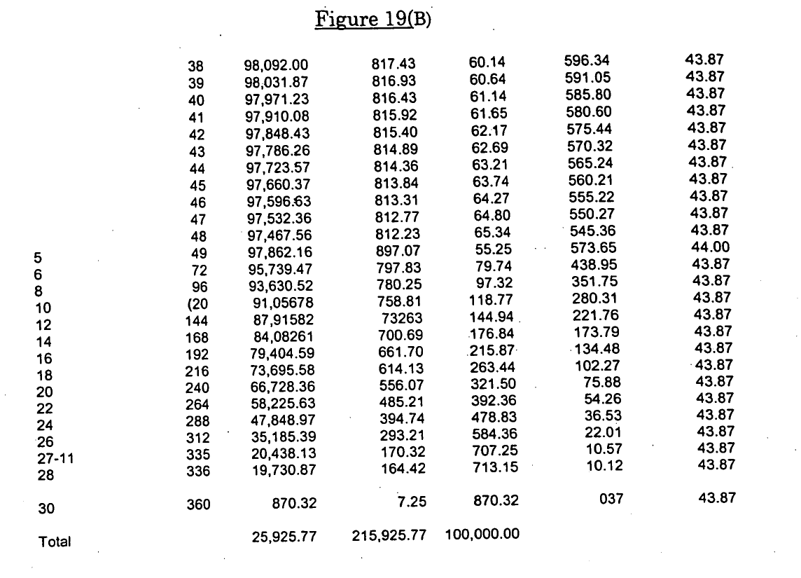

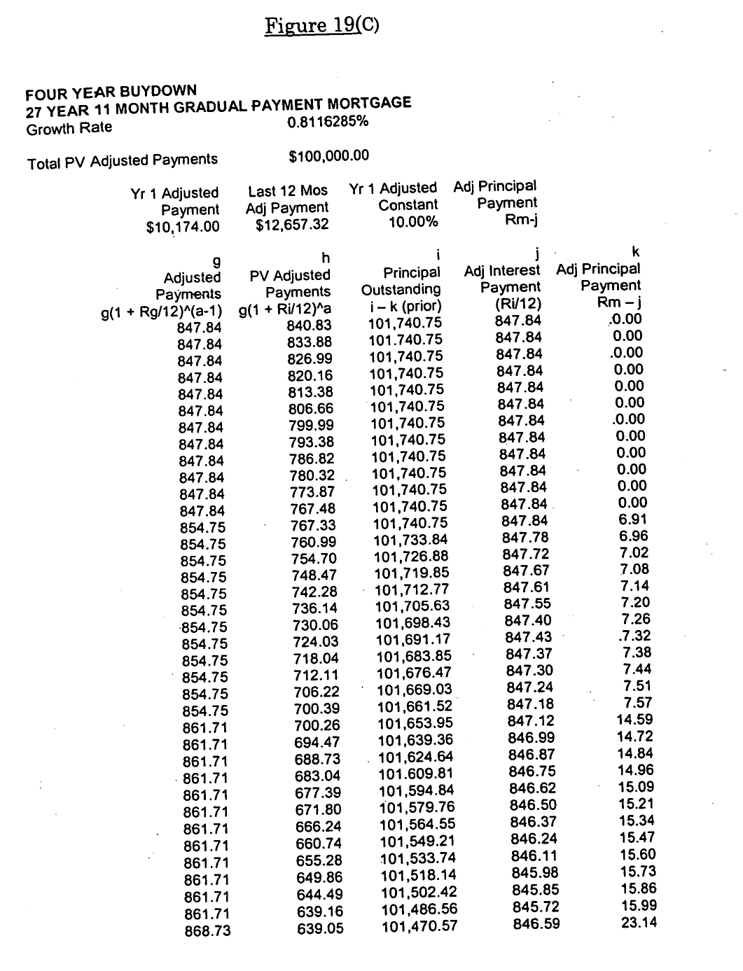

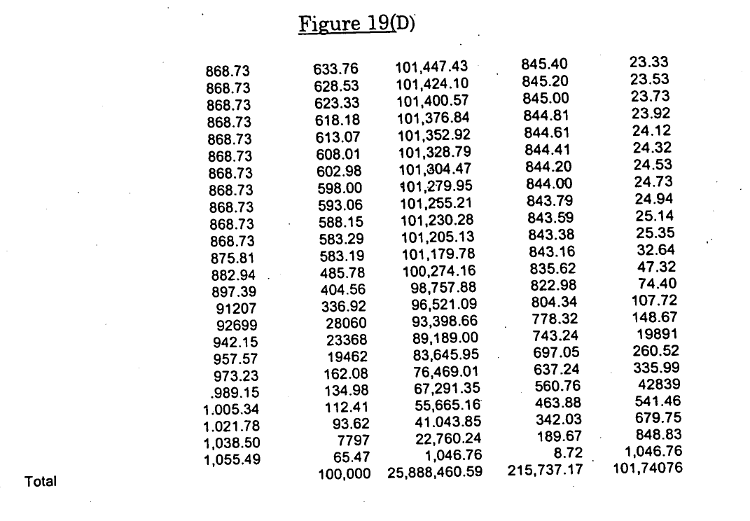

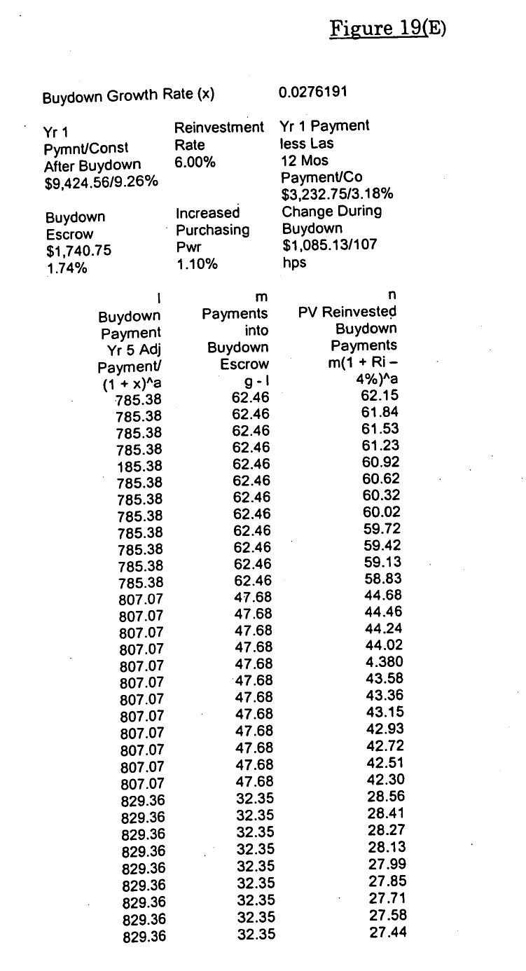

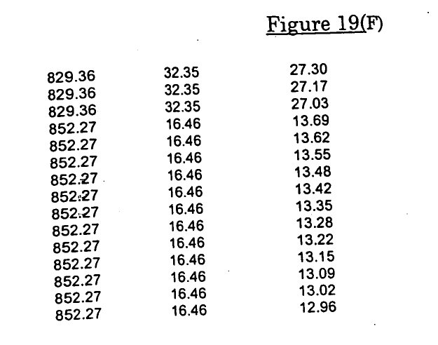

As detailed in FIG. 19, the refinements above all have an impact on the structure of the GSP mortgage with a buydown. Comparing FIG. 19 to FIG. 18, there are distinct differences. First, to reflect the cost of borrowing the funds needed for the buydown escrow, the principal balance in column i has been increased by the amount of the buydown fee. Second, as calculated in column n, the buydown fee has been reduced by assuming that the funds escrowed will earn interest, which is conservatively estimated at 6% (the loan's coupon less 4%). Third, the term of the loan has been reduced from 30 years to 27 years 11 months, so that the total amount of interest paid over the term of the GSP mortgage in column j is approximately the same as the total interest for the comparable 30-year conventional mortgage in column c. As a result of the preceeding refinements, the growth rate for the adjusted payments had to be raised from 0.6371446% to 0.8116285% and the growth rate for the bought down payments from 2% to 2.76191%.

In order to incorporate the refinements described above, the size of the buydown fee had to be increased from $1,325 to $1,740 (1.74% of the $100,000 borrowed net of the buydown). The first year's payment after the buydown was $9,424.56, which yields $10,530.86/$9,424.56=111.74% greater purchasing power than a borrower could qualify for using a comparable 10% conventional 30 year mortgage with its $10,530.86 constant payment. Netting out the 1.74% buydown fee, the additional purchasing power is 10%. Finally, as a result of the higher growth rate for the buydown, the change in payments over the buydown rose from $781 to $1,085 (which represents a 107 bps increase over the first year's payment). This means that payments will increase about 27 bps each year of the buydown, which are likely quite manageable over a four-year buydown. FIG. 19 shows that the difference between the first and last years' payments has risen from $2,552 to $3,232.75 (3.18% of the total amount borrowed). Subtracting the 1.07% increase during the buydown means that the remaining payments rise 2.11 percentage points to maturity, which translates to an average step of slightly less than 10 bps per year.

Overall, it can be seen through the above example that making the changes described above is not a linear process because several objectives are satisfied at the same time. First, the year one payment after the buydown had to yield 10% additional purchasing power net of the buydown fee. Second, total interest over the term of the GSP loan had to be approximately the same as a comparable 30-year mortgage. Third, the adjusted payments in column g (of FIG. 19) for the first 12 months could not be less than the amount of interest charged against the total amount borrowed (or else there would be unwanted negative amortization). And, finally, the present value of the adjusted payments had to be precisely the same as the balance of the comparable conventional mortgage plus the buydown fee (which means the final payment of principal in column k had to equal the outstanding principal balance of the GSP loan in column i).

Naturally, satisfying the foregoing objectives was a balancing act and an iterative process. One can began by increasing the principal balance of the loan by a rough estimate of the buydown fee. Then, one lender can chose a term less than the 30-year conventional loan and select an initial payment approximately the same as the monthly interest payment on the estimated principal balance. Next, a growth rate for the buydown may be selected such that the growth rate would yield approximately the 10% of additional purchasing power desired. After that, the growth rate for the adjusted payments is determined, where the growth rate would yield approximately the same present value as a comparable conventional loan plus the buydown fee. Progressively smaller adjustments are then made to the term, the year one adjusted payments and both growth rates, until arriving at the final structure detailed in FIG. 19.

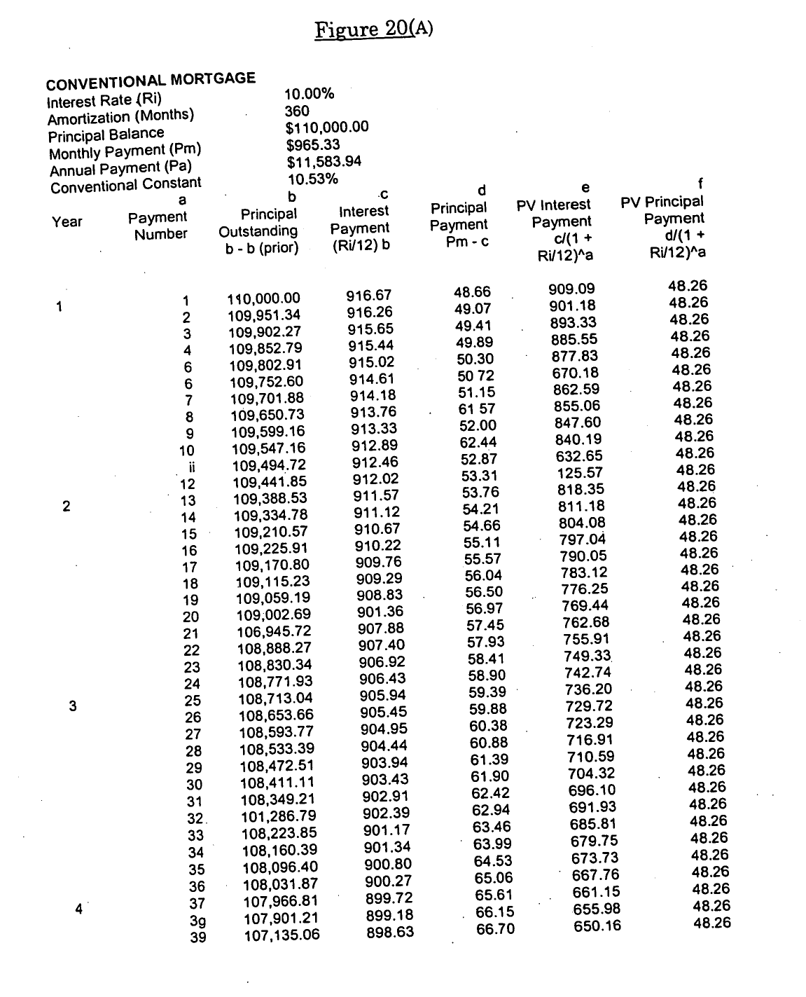

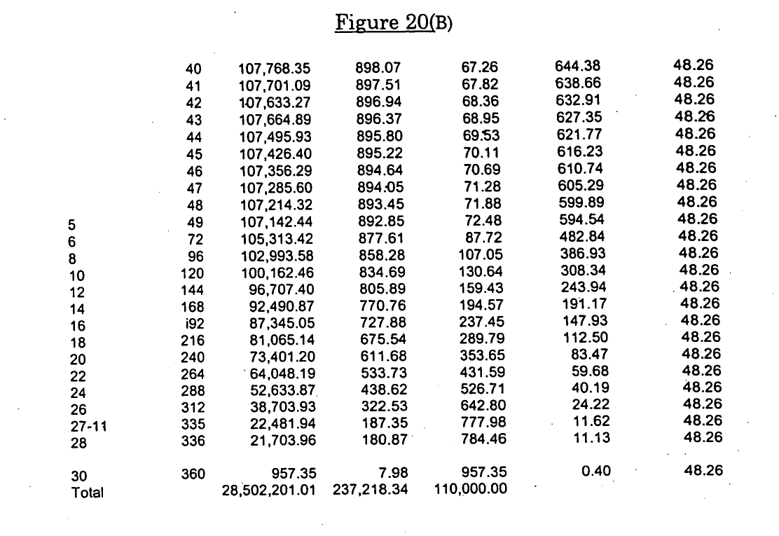

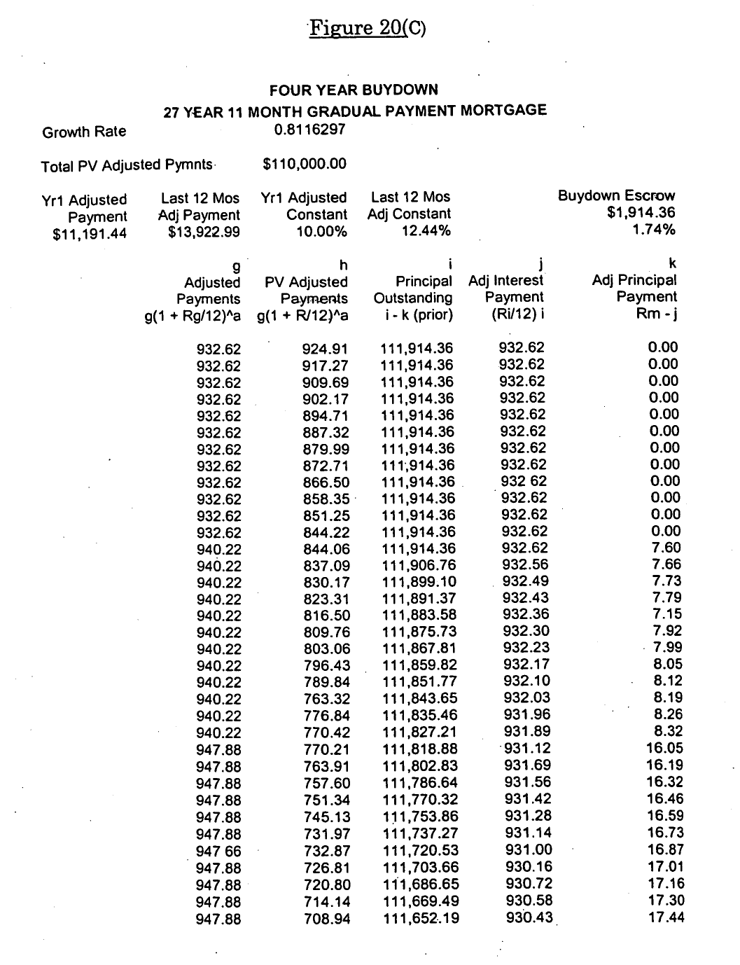

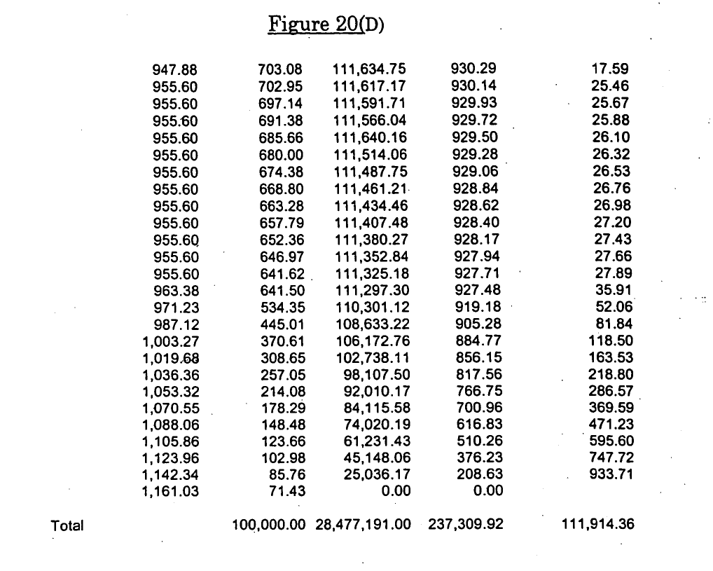

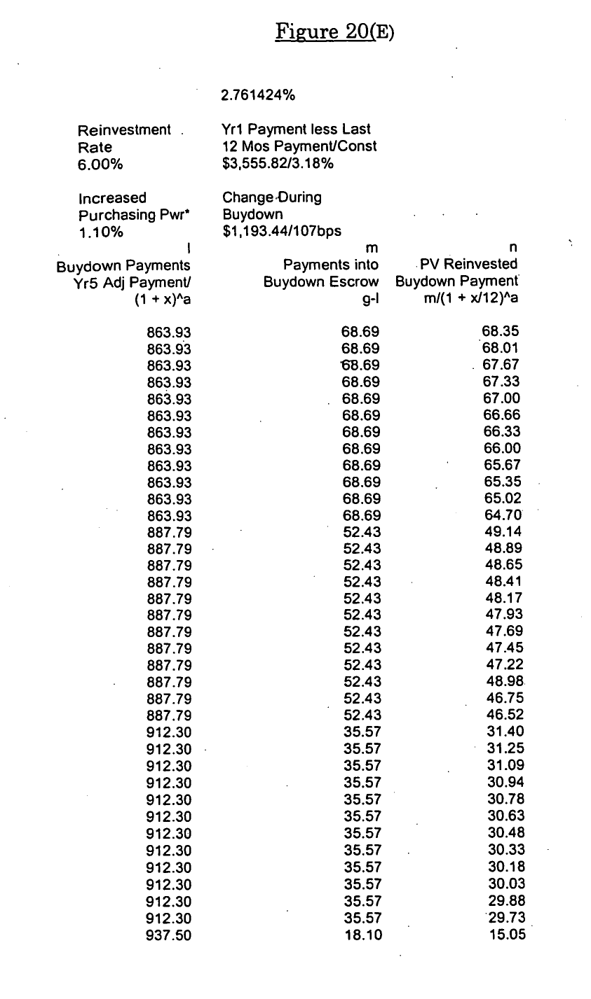

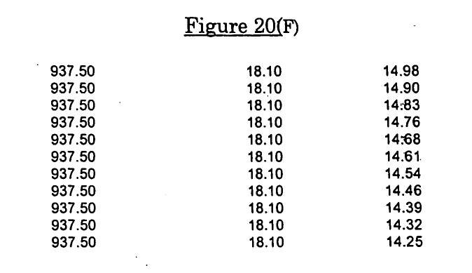

Using the refined 10% GSP mortgage for $100,000 in FIG. 19, one can construct the exemplary $110,000 GSP loan detailed in FIG. 20 by simply increasing the first year's adjusted monthly payment by the 10% additional purchasing power. Note how the buydown fee is 10% greater than the smaller loan's buydown fee. Also, the respective changes in payments during the buydown and over the term of the loan are the same 107 bps and 3.18% of the total amount borrowed as they are for the smaller loan. The only change in parameters is a slight modification of the growth rate for the adjusted payments from 0.8116285% to 0.8116297%. This miniscule change is required to adjust for the rounding error. In contrast, the modification to the growth rate does not occur until the eighth decimal place (i.e., the closest hundred millionth). Such precision is needed to make sure the final principal payment is exactly the same (to the penny) as the principal outstanding on the maturity date and, as unlikely as it might sound, is easy to achieve with a basic desktop computer.

Administering the escrow for the buydown fee should be straightforward. It may be maintained by the entity receiving the borrower's monthly payments. Upon receipt of the borrower's payment, a certain amount would be released from the escrow, so that the GSP mortgage's full adjusted monthly payment would be made. Unlike a tax escrow or insurance escrow, there would be no need to review and revise payments from year to year. They would be known at the time that the loan was made.

Any interest earned on the escrow in excess of that used for monthly payments could be paid to the borrower at the conclusion of the buydown period, along with the interest earned that year on the tax and insurance escrow. If the loan were prepaid, any balance in the escrow would be returned to the borrower along with accrued interest. At no time would the borrower be involved or burdened with the administration of the buydown escrow. For all practical purposes, the borrower should view the buydown fee as no different from points on a conventional mortgage.

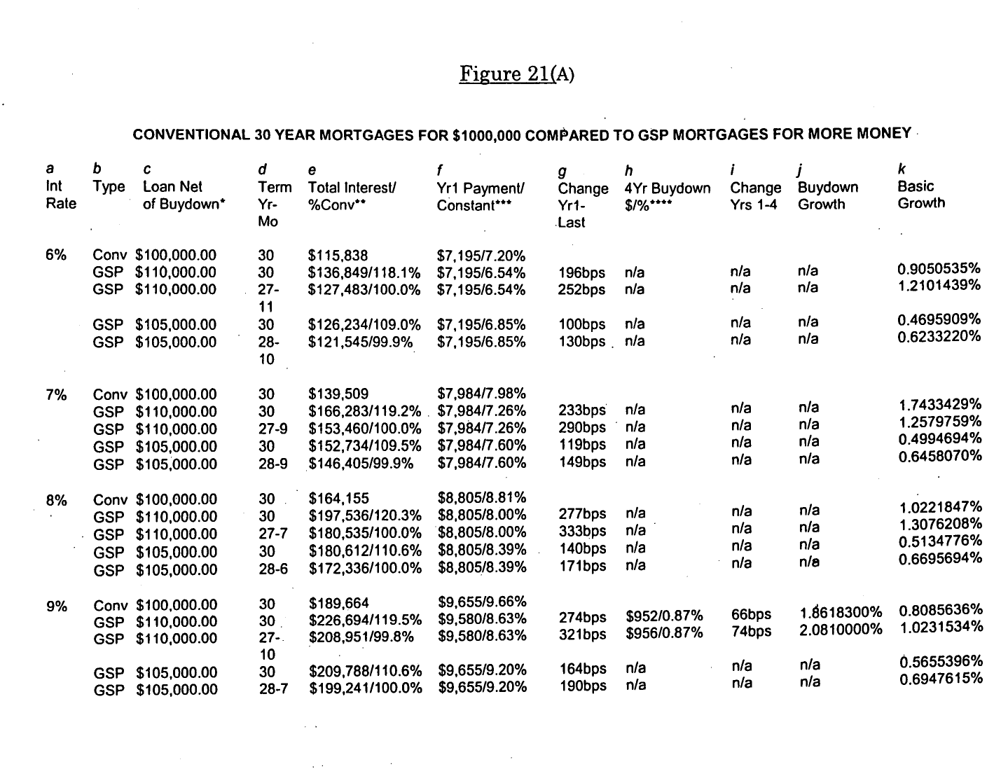

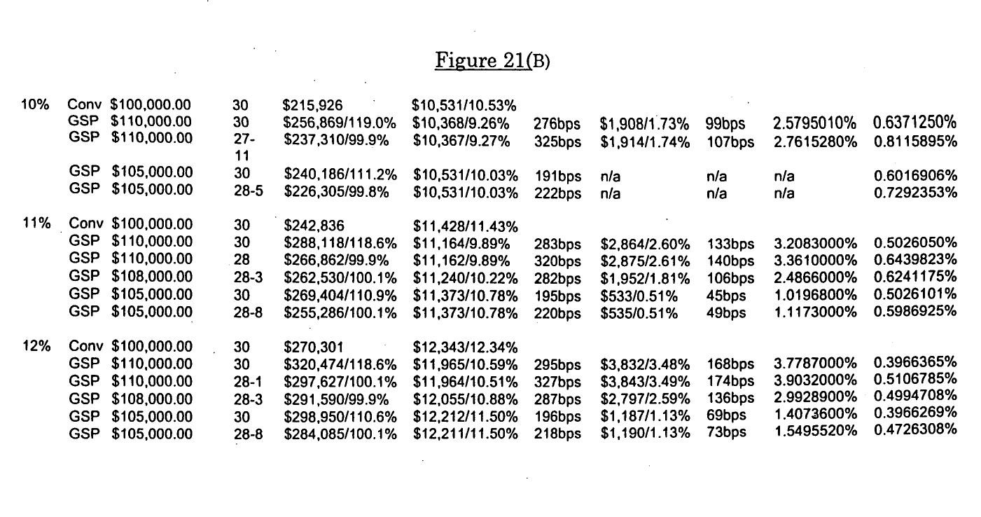

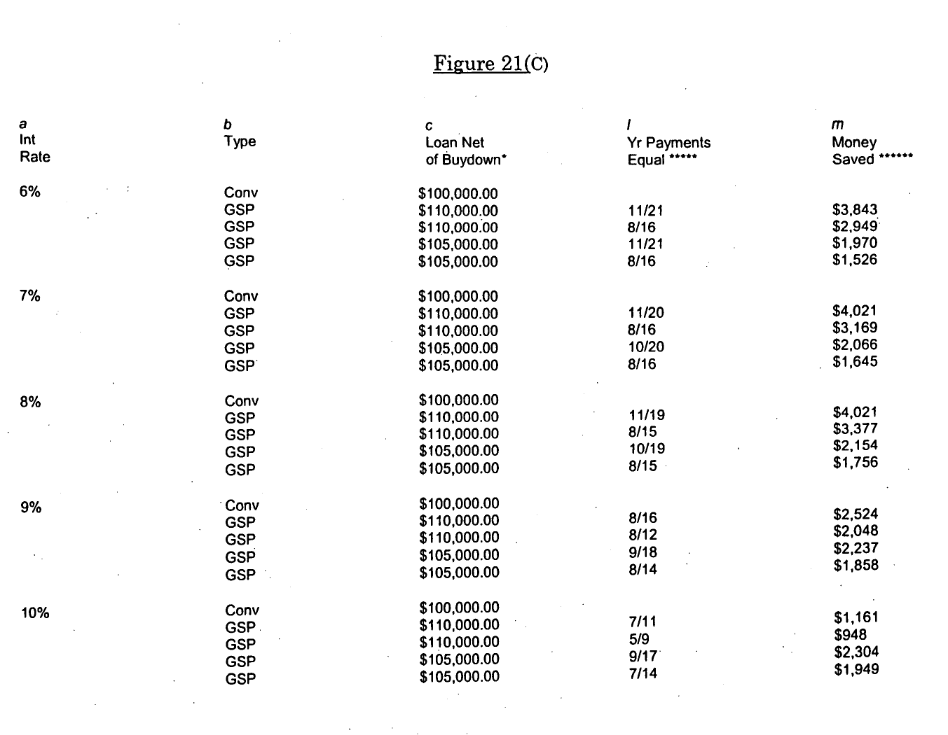

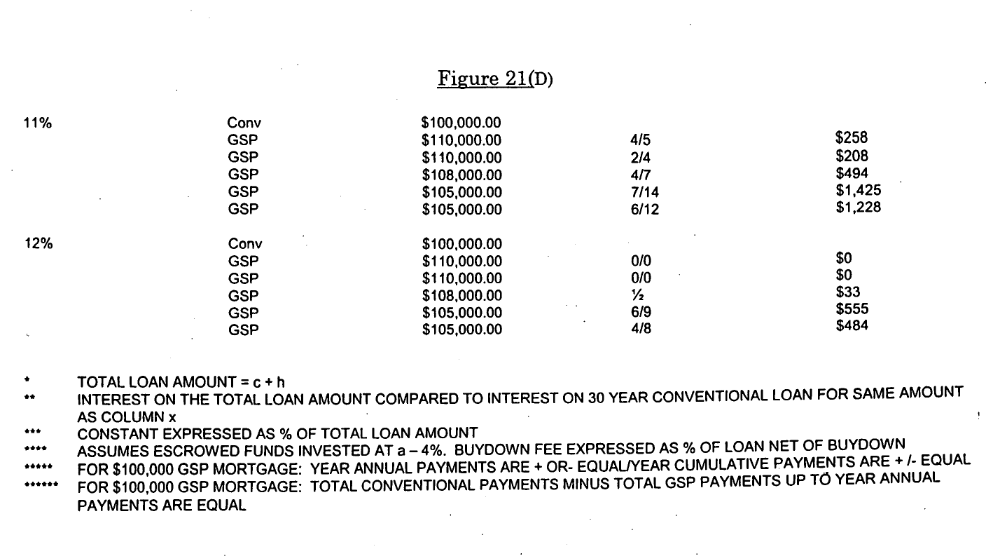

Different configurations of GSP mortgages may be formed using buydowns. As discussed above, to enable 10% more purchasing power, the first year's GSP payment should be approximately 91% of the fixed payment for a comparable conventional loan. FIG. 13, discussed above, illustrated that the first year interest only payments of 30-year GSP mortgages will exceed that 91% breakpoint at rates above 8%. This means that buydowns may be needed for GSP loans yielding 10% additional purchasing power at rates above 8%. FIG. 21 details GSP mortgages with 10% additional principal as well as the buydowns required to avoid negative amortization at rates above 8%. To provide a frame of reference, it also includes 30 year conventional loans for $100,000, as well as other GSP mortgages with as little as 5% more principal.

Each GSP mortgage with a buydown in FIG. 21 is calculated with the buydown fee in its principal balance. However, column c of FIG. 21 shows the loan proceeds net of the amount of the buydown fee for the GSP loans. Column d shows how the terms of some of the GSP loans have been reduced slightly below 30 years. As illustrated in column e, this allows the total interest of those GSP loans to be approximately the same as conventional 30-year loans for the same amount of money. In contrast, the 30-year GSP loans charge from 109.0% to 120.3 % more interest to maturity than the conventional 30-year loans.

Continuing with FIG. 21, column f details how the first year payments of the GSP loans are the same or less than the smaller conventional 30 year mortgages for $100,000. Column f also lists the year 1 constants calculated as the first year's payments divided by the total amount borrowed (which includes the buydown fee). When the first year constants are less than the interest rate, buydowns are needed to avoid negative amortization. Column h details the buydowns. Without a buydown escrow to supplement payments, these loans would have shortfalls in interest that would have to be added to the principal balance. For the GSP loans $10,000 (10%) larger than the $100,000, conventional loans buydowns are needed at interest rates above 8%. For the loans with $5,000 (5%), additional proceeds buydowns are required only at interest rates greater than 10%.

Referring again to FIG. 21, as shown in column g, the change between the first and last years' payments expressed as constants increases from as low as 196 bps for the 30 year $110,000 GSP loan at 6% to as much as 333 bps for the 27 year 11 month loan at 8%, and holds relatively steady for the $110,000 loans at higher rates that have buydowns. This change represents an increase in payments of 196/654=130% over the life of the 6% loan and 327/1051=131% for the 12% loan. Borrowers should find such changes quite manageable over a 28 to 30 year timeframe. In the loans with buydowns, however, the changes are not constant and are concentrated most heavily over the period of the buydown. Therefore, a more relevant perspective is what these changes mean on an annual basis. For example, over the 27 year 11 month term of the 6% loan with no buydown, there would be 27 steps in payments, which translates to just a 252/27=9 bps average increase per year. This compares very favorably to the 2 percentage point (200 bps) increase a borrower could incur in just one year of an ARM loan and underscores the minimal default risk associated with the GSP mortgage's 1.21% growth rate shown in column k. The 27 year 11 month $110,000 GSP loan at a 10% interest rate would have a 1.74% buydown fee and a 2.761% buydown growth rate shown in column i Column j shows this results in a 107 bps increase in payments over the four-year period of the buydown. This change is only slightly more than half the amount an ARM could rise in any one year and just 107/4=27 bps per year of the buydown. The loan will increase 325−107=218 bps during the years following the buydown at an average annual increase of about 10 bps. With less than 2 points for a buydown and such modest annual steps in payments, this $110,000 mortgage at a 10% interest rate should be readily accepted by most borrowers. Moving to an 11% interest rate, the buydown fee is 2.61% for the 28 year GSP loan, while the payments rise 140 bps (or 35 bps per year) during the four-year buydown. Assuming the buydown fee will be borrowed, such numbers may still appeal to many borrowers. At a 12% interest rate, the buydown fee jumps to 3.49% for the 28 year 1 month GSP loan, and the payments increase 174 bps over the buydown at a growth rate of 3.903%. The 174 bps is still less than an ARM can increase in any one year and an average step of 43.5 bps during each year of the buydown. After the buydown, the remaining increase in payments to maturity is 153 bps, which is an average increase of only 7 bps per year. One probably cannot expect many people to pay 3.49 points to borrow 10% more than they can get with a conventional loan. However, some will probably be indifferent as long as they can borrow the fee and still get 10% more proceeds than they could afford with a conventional 30-year mortgage.

Note that while the 30 year GSP mortgages charge more total interest to maturity, they offer lower growth rates than the comparable, but slightly shorter, GSP loans. As shown in columns l and k of FIG. 21, most of the 30 year GSP loans take longer to break even with conventional 30 year mortgages for the same amount of money and, consequently, offer greater near term savings. Borrowers and lenders will have to weigh these tradeoffs between near term benefits and total interest. Since experience indicates that most borrowers will not hold their loans for more than about 10 years, they are likely to prefer the 30 year GSP loans with their lower growth rates.

To place things in perspective, 30 year mortgage rates have not exceeded 10% since 1991 and have generally ranged between 7% and 9% thereafter. This means that the points required to buy down a GSP mortgage with 110% additional purchasing power are not likely to be a problem for borrowers. Nevertheless, the 1980's showed that mortgage rates could reach 11% and above. In case the increases in payments during the buydowns for the $110,000 GSP mortgages yielding 11% and 12% are too steep for some lenders or borrowers, FIG. 21 includes $108,000 GSP loans, as well. The 136 bps change over the 4-year buydown of the $108,000 GSP loan at 12% seems pretty tame. Given this manageable increase in near term payments, many borrowers may be willing to pay the buydown fee of 2.59 points for a full 8% more purchasing power at the 12% rate.

For those people who want to borrow more money than they can obtain with a 30 year conventional mortgage, but prefer to pay even more gradual increases in their annual installments, the $105,000 GSP loans shown in FIG. 21 would clearly fit the bill at any of the interest rates shown. For the 30-year GSP mortgage at 6%, the average annual increase is a mere 100 bps/29=3.5 bps a year, while at a 12% rate, it is still a very modest 218 bps/28=8 bps a year for the 28 year 8 month term. For the $105,000 GSP loans, a buydown is not needed before reaching the 11% interest rate. Even then, the buydown fee is a just 51 bps, and the average increase during the 4-year buydown is only approximately 12 bps a year. At the 12% rate, the buydown fee is a nominal 1.13%, while the increase during years 1 through 4 averages only 18 bps a year and 5 bps each year thereafter. Clearly, using a GSP mortgage to borrow 5% more than they could with a conventional fixed payment loan would be a painless proposition for most borrowers and pose virtually no incremental default risk to their lenders.

As seen in FIG. 12, it is possible to achieve more than 10% additional purchasing power without a buydown,—as long as the interest rate is less than 8%. For example, a 7% GSP mortgage would yield 14% additional proceeds with a 1.312% growth rate and 324 bps gap between the first and last years' payments. If the term of a GSP is shortened to make total interest to maturity approximately the same as a conventional 30 year mortgage, the resulting GSP loan would have a term of 27 years 1 month, a 1.730% growth rate and a 399 bps gap between its first and last years' payments. Naturally, if borrowers wanted more than 10% additional purchasing power at rates of 8% or above, they would have to use buydowns and be comfortable with the buydown fees and growth rates required to achieve that additional purchasing power.

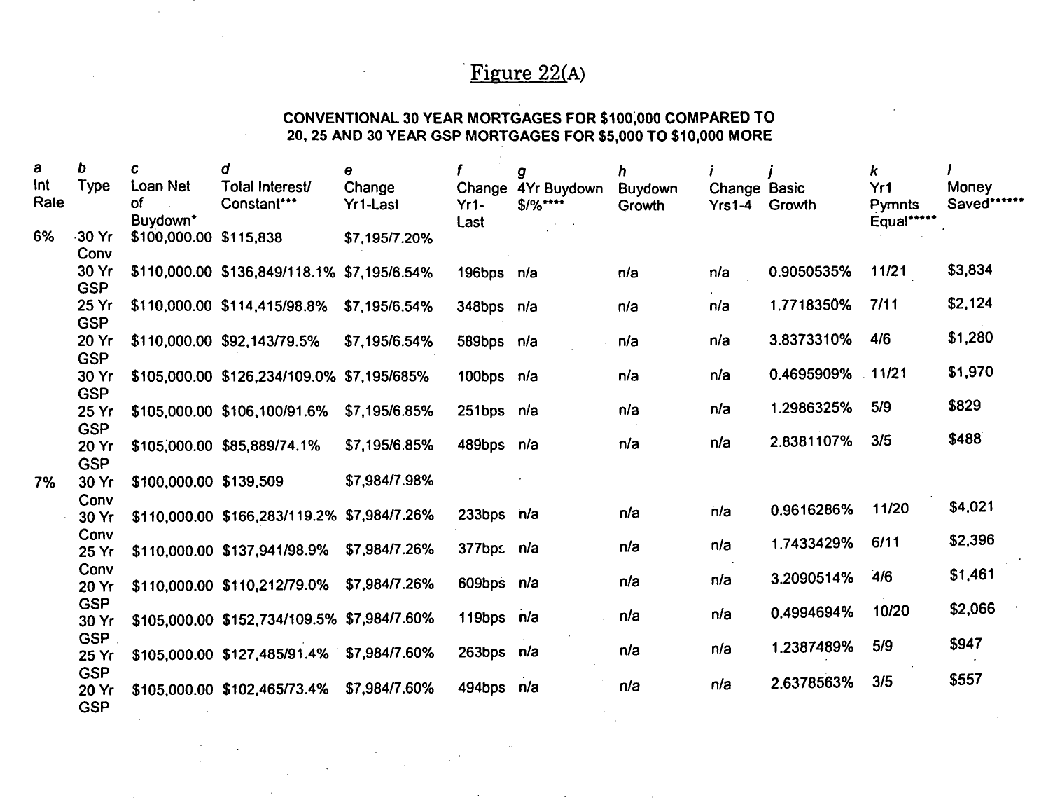

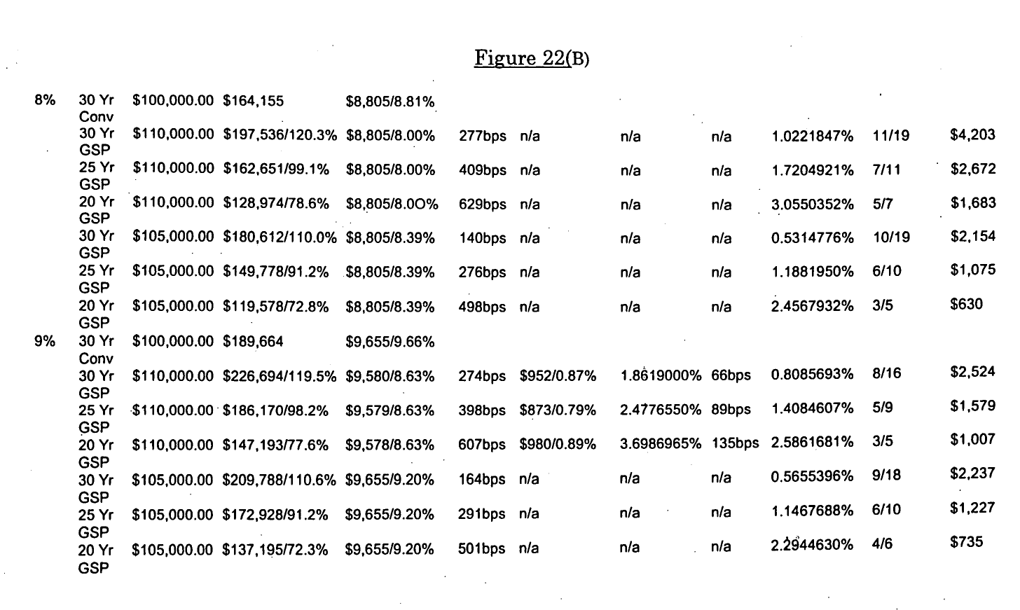

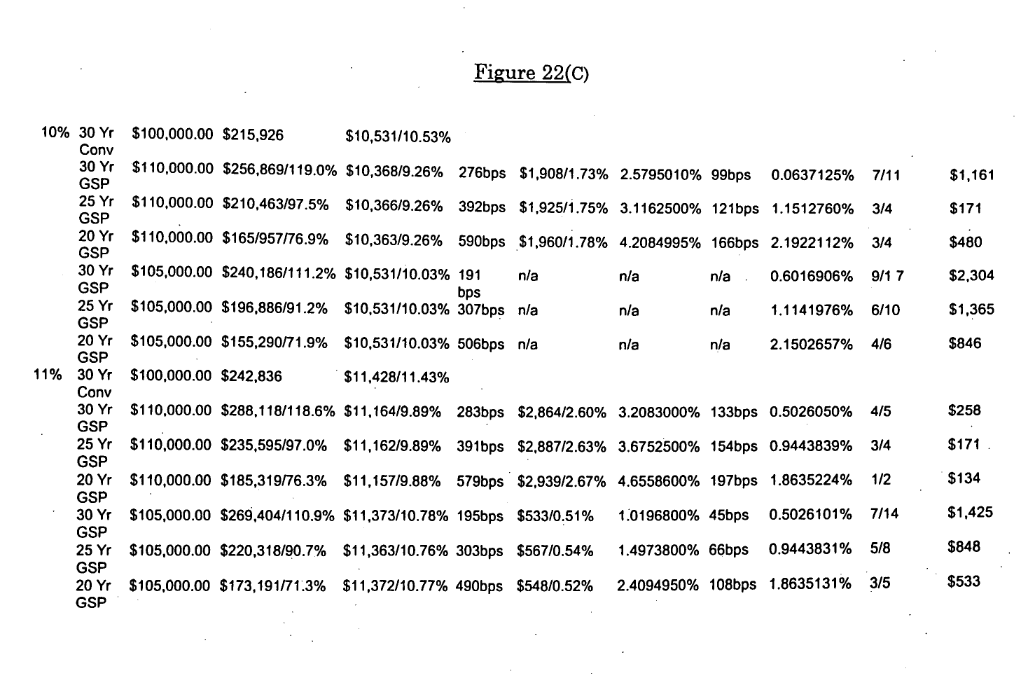

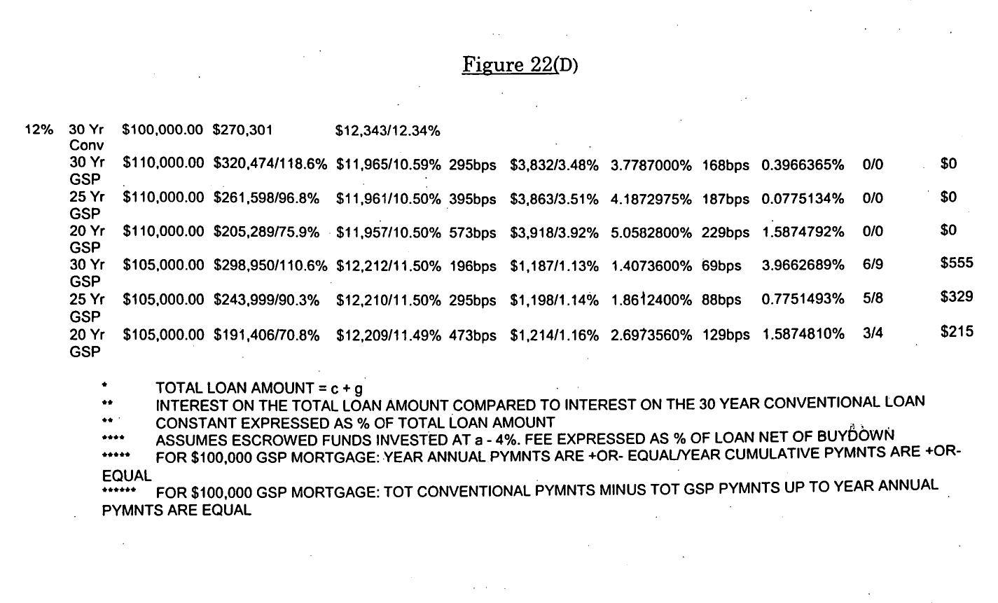

Borrowers may also use buydowns for additional purchasing power at shorter maturities. FIG. 22 details 20 and 25 year GSP loans that provide 5% and 10% more proceeds than conventional 30 year mortgages. To provide a frame of reference, FIG. 22 also shows 30-year GSP loans for the same proceeds. As discussed earlier, in order to avoid negative amortization the loans with 10% additional purchasing power need buydowns at rates of 9% and above, but the loans with 5% additional purchasing power require buydowns only at the 11% and 12% interest rates.

Comparing the $105,000 GSP loans, it can be seen that the shorter the maturity, the higher the buydown growth rate, the greater the change in payments during the buydown period and the wider will be the gap between the first and last years' payments. The same things hold true when comparing the $110,000 GSP loans.

As one would expect when comparing the 25 year GSP mortgages for $105,000 and $110,000, the (reduced) additional purchasing power results in a lower buydown fee and a smaller change between the first and final years' payments. However, when comparing the 30 year GSP mortgages for $110,000 to the 25 year loans for $105,000, the longer term enables a borrower to borrow more money and still have lower growth rates with substantially similar (or even smaller) gaps between first and last years' payments. This is also the case, in fact even more so, when comparing the 25 year GSP mortgages for $110,000 to the 20 year loans for $105,000.

Focusing on the shorter term loans for $105,000, the gap between the first and last years' payments is shown in column f of FIG. 22 and the growth rate is depicted in column j. Both are easily manageable at any of the interest rates shown for a 25 year $105,000 GSP loan. For the loans without buydowns, the gap ranges from between 251 bps to 307 bps and the growth rate varies from 0.775% to 1.298%. For the 25-year loans with buydowns, the fees escrowed are just 0.54% and.1.14% at the 11% and 12% interest rates, respectively. Similarly, the change in payments during the four-year buydowns is a reasonable 66 bps and 88 bps for those respective interest rates. In contrast, the 473 bps to 506 bps gaps between the first and last years' payments for the 20 year $105,000 GSP loans may be too high for most borrowers. The growth rates for the 20-year loans are also higher. For loans without buydowns, the growth rates range from 2.150% to 2.838%, while the growth rates for the 11% and 12% that require buydowns are 1.863% and 1.587%, respectively. However, with buydowns included, the respective average compound growth rates for the 11% and 12% loans increase to 1.993% and 1.831%.

Moving to the shorter term $110,000 GSP mortgages in FIG. 22, the gap between the first and last years' payments ranges from 348 bps to 409 bps for the 25 year loans, and the growth rates vary from 0.775% to 1.771%. However, the buydowns can be pretty sizable, more than quadrupling from a 0.79% fee at the 9% rate to a 3.51% fee at 12%. When accounting for these buydowns, the growth rates rise from 1.408% to an average compound rate of 1.461% for the 9% loan and from 0.775% to an average compound rate of 1.329% for the 12% loan. Though clearly higher than the gaps and growth rates for the loans with less additional purchasing power, these numbers may be acceptable to borrowers who want the extra proceeds. However the buydowns required for the 12% loans are large enough that, assuming they are borrowed, the first year payments on these $110,000 loans are higher than the constant payments for a conventional 30 year fixed rate loan for $100,000. As a result, some people may prefer the smaller buydown fees and more gradual changes associated with the $108,000 GSP loans in FIG. 21. As for the 20 year GSP loans for $110,000, the gaps between first and last years' payments run from 573 bps to 629 bps. This would appear to be too high for all but a few borrowers. Naturally, at maturities less than 20 years, the gaps and the growth rates would become prohibitively large.

To summarize FIG. 22, people would be reluctant to select GSP loans of 20 years or less, when they need to borrow more than they could afford with conventional fixed rate 30 year loans. Instead, borrowers seeking additional purchasing power should be most comfortable with GSP mortgages of 25 years or longer.

Determine Timing of Changes in Monthly Payments 140

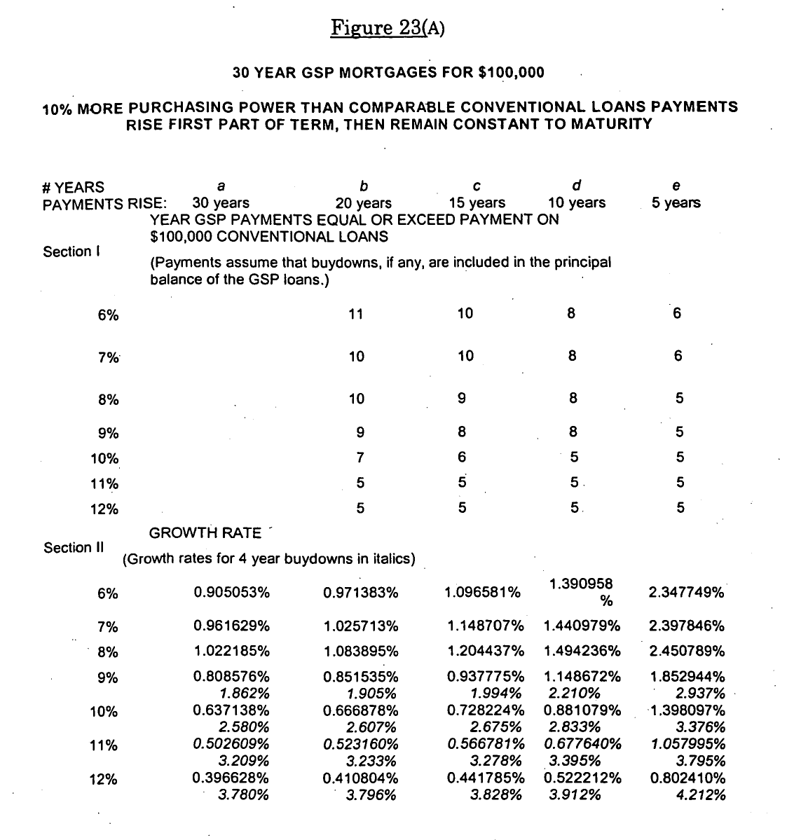

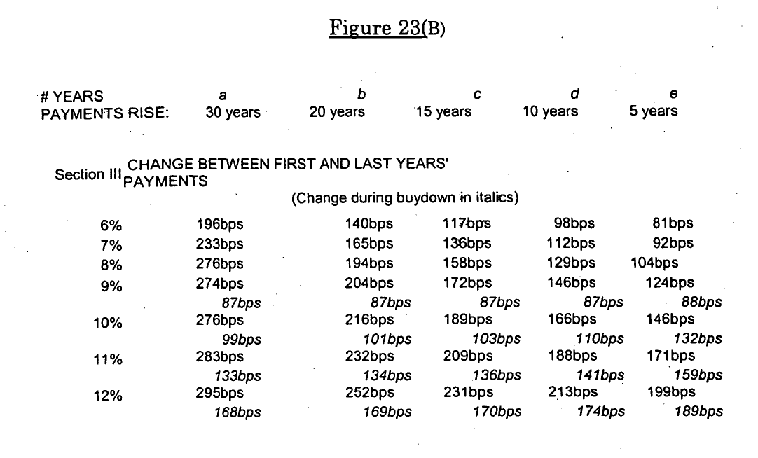

While the examples provided above describe GSP loan payments that increase over the life of the loan, GSP loans can be modified to have constant payments after a period of gradually stepped payments. In all other respects the calculation of these modified GSP loans would be the same as heretofore discussed. Using standard 30-year GSP loans as benchmarks, FIG. 23 details some of the fundamental characteristics of these modified thirty year loans where the payments stop increasing after stepping up for 5, 10, 15 or 20 years. The loans in FIG. 23 have initial payments calculated to provide 10% greater purchasing power than comparable conventional loans.

Section I of FIG. 23 shows the year in which the GSP payments equal or exceed the constant payments of a conventional 30 year fixed rate mortgage. Borrowers with more years to break-even have greater near term savings. For lenders and investors, as long as the GSP payments are below those of a comparable fixed rate conventional loan, the less likely a GSP loan will be prepaid before the conventional loan. Note that there is only a slight difference between the break-even periods for the benchmark GSP loans in column a whose payments step up each year to maturity and those whose payments level off after 20 years or, to a somewhat lesser extent, 15 years. At lower interest rates, that break-even period shortens materially for the GSP loans whose payments level off after 10 years or less, so there appears to be little reason borrowers or lenders would prefer those configurations. However, this distinction is not as clear for the loans at the higher interest rates where, as seen in FIG. 22, the GSP payments step up more rapidly during the buydown period. Therefore, at higher interest rates, the decision as to how long to grow GSP payments before holding them flat may be less clear-cut.

The middle Section II of FIG. 23 shows the growth rates for the different configurations of GSP loans, as well as the growth rates required for those loans with buydowns. Just as in the section above, there does not appear to be a large difference between the GSP loans whose payments increase every year and those whose payments level off after 20 (or two-thirds the term). At lower interest rates, the difference in growth rates is quite pronounced for the GSP loans that level off after 10 years and even greater for those that stop increasing after 5 years. For the GSP loans at higher interest rates, however, the growth rates during buydowns vary much less for all configurations except those whose payments become constant after only 5 years. As a result, some Borrowers may be less inclined to prefer the higher interest rate loans that step up for most of the term.

The final Section III of FIG. 23 illustrates the difference between the GSP loans' first year and constant final payments. Please keep in mind that for the basic GSP loans whose payments increase every year to maturity the difference does not exceed 300 bps, which seems to be pretty tame for a 30 year term and, perhaps, irrelevant to most borrowers who are unlikely to keep their loans for more than half the term. Regardless, some borrowers or lenders may feel more comfortable knowing their payments will not rise for the entire term of their loans. For these borrowers, the GSP loans with rates of 10% or less that do not level off for at least 20 years may prove attractive. Depending on the interest rate, the difference between the first year and constant final payments for these loans is less or not much more than two percentage points (200 bps). Since ARM loans can increase that much in just one year, there should not be a need for flat GSP payments sooner than 20 years. Also, allowing payments to step up for two thirds of the term results in growth rates and break-even periods that are only slightly different from the benchmark 30-year loans, described above. However, this does not hold true at higher interest rates. As a result of the sizable buydowns for the 11% and 12% GSP loans with 10% additional purchasing power, payments can level off after 10 years with no material impact on growth rate, break-even period or the change between the first year and constant final payments.

Conclusion

A 1-year ARM today would have a rate of 5.04% with an annual payment that translates to a 6.47% constant. If the rate rises 2 full percentage points in a year, that would result in a 7.97% constant and a 7.97/6.47=23% increase in payments. For an investor or lender with a portfolio of adjustable rate loans, a jump in payments of such magnitude is likely to increase the default rate on that portfolio. Furthermore, a sustained upward shift in the level of interest rates could result in the ARM jumping the maximum allowable 6 percentage points to a 11.04% rate in as few as 3 years. This would have a constant of 11.36% and translate to a 11.36/6.47=75% total increase in payments. On the other hand, conventional 30-year mortgages today have an average fixed rate of 6.11% with a constant of 7.28%, which is just 81 bps higher than the 6.47% payment of the ARM. A comparable 30 year GSP mortgage with 10% additional purchasing power at the 6.11% rate would have a first year constant of 7.28/1.10=6.62%, which is nearly as low as the 6.47% constant for the 5.04% ARM. Whereas the payments for the ARM could increase as much as 589 bps (75%) in three years, the GSP loan would increase only 28 bps over the same period of time, which means that the GSP loan will have a dramatically lower default risk.

Since 1999 the gap between the interest rates on 30-year fixed rate and 1 year adjustable rate mortgages has ranged from approximately 100 bps to 220 bps. At the widest point, the 30 year fixed rate was approximately 8.45% and the floating rate 6.25%, which translate to constants of 9.18% and 7.39%, respectively. A comparable 30 year GSP mortgage with 10% additional purchasing power would have a first year constant of 9.18/1.10=8.35%, which is 96 bps higher than the ARM. Here the initial GSP payment would just about split the difference between the conventional loan's fixed payment and the ARM. But after one year, the ARM could exceed the GSP payment by approximately one full percentage point and then rise to a 12.57% constant two years later. That would equal a 12.57/7.39=70% increase in the ARM's payments over a three-year period, which still poses a much higher default risk than a GSP loan whose payments grow about 1% per year. The higher the interest rate, the lower becomes the percentage increase possible for an adjustable rate loan: for an ARM charging 10%, a 6 percentage point increase in rate would result in a 53% increase in payments; whereas, a full 6 percentage point rise above a 12% rate would result in a 47% increase.

The foregoing examples underscore why GSP loans can be such a good alternative to ARMs. They can give borrowers nearly all or a good portion of the near term savings of adjustable rate mortgages, while greatly reducing the default risk for the investors and lenders who hold the loans in their portfolios or guarantee their repayment. And, for borrowers who want to pay off their adjustable rate loans during a period of rising interest rates, GSP mortgages can enable lenders to offer them a more affordable fixed payment alternative than conventional fixed payment loans.

Several other benefits of the GSP loans are now summarized. If interest rates fall, borrowers with adjustable rate mortgages will be happy to hold onto their loans, but those with conventional fixed rate mortgages are likely to prepay in exchange for fixed rate loans with lower payments. The fact that longer term GSP mortgages will have lower payments than comparable conventional fixed payment loans for the first 8 to 10 years should make it less likely that the GSP loans will be prepaid as soon as comparable fixed payment loans. The lower early payments of the GSP mortgages should also result in a lower default rate for the GSP loans, until their payments begin to exceed the constant payments of the conventional loans. By that time, however, most borrowers will have paid off their loans as a result of selling their homes or refinancing their mortgages. Thus, the GSP mortgages would appear to have both a lower prepayment risk and a lower default risk than conventional fixed payment mortgages. The exception would be those borrowers who use GSP loans to obtain greater proceeds than they could qualify for with a conventional constant payment loan. Although the modest increases in payments of a GSP mortgage should not be a problem for most borrowers, the simple fact that they will increase gradually to maturity suggests that they will have a default rate marginally higher than a comparable fixed payment conventional loan. Lenders can identify borrowers who need GSP mortgages for additional purchasing power, not near term savings, and price those loans accordingly.

Investors preferring a stable income stream should be attracted to GSP loans because they amortize more slowly than conventional fixed payment mortgages. Slower amortization means a steadier stream of near term interest payments and reduces the need to reinvest the principal repaid each month. The prospect of a steadier stream of interest together with lower prepayment risk should make GSP mortgages an attractive investment alternative to constant payment loans. However, as suggested above, GSP loans used for additional purchasing power rather than near term savings should carry a premium in yield to compensate investors for any incremental default risk associated with their schedules of gradually increasing payments.

GSP loans have two characteristics that create greater risks to lenders than conventional long term fixed rate mortgages: a schedule of rising payments and slower amortization. The lower the initial GSP payment in relation to the constant payment of a comparable fixed rate mortgage, the greater will be the additional purchasing power, the faster its payments will grow and the more slowly the GSP loan will amortize. Naturally, lenders would be expected to charge more fees and/or a higher interest rate for a GSP loan offering 10% additional purchasing power than one providing 5% additional purchasing power. As a result, some borrowers may prefer the cost savings inherent in a GSP loan that offers less additional purchasing power or one that has a higher growth rate and, therefore, amortizes more quickly.

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the system of the present invention may be modified as needed to meet the requirements of computer networking schemes and configurations as they are developed. It is intended that the scope of the invention be limited not by this detailed description, but rather by the claims appended hereto. The above specification, examples, and data provide a complete description of the manufacture and use of the composition of the invention. Since many embodiments of the invention can be made without departing from the spirit,and scope of the invention, the invention resides in the claims hereinafter appended.

1. A method for forming a lending instrument, the method comprising the steps of:
(a) selecting a principal to be borrowed;
(b) defining an interest rate;
(c) selecting a loan term;
(d) selecting an initial payment and
(e) calculating a growth rate whereby a stream of payments, as defined by the initial payment, the loan term, and the growth rate, has a present value equal to the borrowed principal, wherein the present value is calculated using the interest rate.

2. The method of claim 1, wherein the stream of payment increases during half or more of the loan term.

3. The method of claim 1, wherein the growth rate is neither a whole number nor a half of a whole number or combinations thereof.

4. The method of claim 1, wherein the growth rate is less than 2% annually.

5. The method of claim 1, wherein the initial payment is greater than or equal to an interest only portion of a fixed rate conventional loan having the same interest rate, principal, and term.

6. The method of claim 1, wherein a comparable fixed rate conventional loan has a reference term and the same interest rate and principal, wherein the initial payment is equal to payments from the comparable fixed rate conventional loan, and the term of the loan is less than the reference term.

7. The method of claim 1, wherein the loan term is selected so that the stream of payments comprises interest-only portions that sum to be approximately equal to total interest paid with an equivalent fixed rate conventional loan.

8. The method of claim 1 further comprising selecting a buydown amount, wherein the stream of payments is further defined by the buydown.

9. The method of claim 8, wherein the buydown amount is included as an increase to the selected principal.

10. A lending instrument created through a process comprising the steps of:
(a) selecting a principal to be borrowed;
(b) defining an interest rate charged for the principal;
(c) selecting a term;
(d) selecting an initial payment and
(e) calculating a growth rate, whereby a stream of payments for the lending instrument, as defined by the initial payment, the loan term, and the growth rate, has a present value equal to the borrowed principal, wherein the present value is calculated using the interest rate.

11. The lending instrument of claim 10, wherein the stream of payments increases during half or more of the loan term.

12. The lending instrument of claim 10, wherein the growth rate is not a whole number or a half of a whole number or combination thereof.

13. The lending instrument of claim 10, wherein the growth rate is less than 2% annually.

14. The lending instrument of claim 10, wherein the initial payment is greater than or equal to an interest only portion of a fixed rate conventional loan having similar interest rate, principal and term.

15. The lending instrument of claim 10, wherein a comparable fixed rate conventional loan has a reference term and the same interest rate and principal, wherein the initial payment is equal to payments from the comparable fixed rate conventional loan, and term of the loan is less than the reference term.

16. The lending instrument of claim 10, wherein the loan term is selected so that the stream of payments comprises interest-only portions that sum to be approximately equal to total interest paid with an equivalent fixed rate conventional loan.

17. The lending instrument of claim 10, wherein the method used to form the lending instrument further comprises selecting a buydown amount, wherein the stream of payments is further defined by the buydown.

18. The lending instrument of claim 17, wherein the buydown amount is included as an increase to the selected principal.

19. A lending instrument comprising a stream of payment, the stream of payments having a predefined initial payment and subsequent payments comprising the initial payment modified by a predefined growth rate, wherein the growth rate is calculated so the stream of payments has present value equal to a borrowed principal.

20. The lending instrument of claim 19, wherein the growth rate is not a whole number or a half of a whole number or combination thereof.

21. The lending instrument of claim 19, wherein the growth rate is less than 2% annually.

22. The lending instrument of claim 19, wherein a comparable fixed rate conventional loan has a reference term and the same interest rate and principal, wherein the initial payment is equal to payments from the comparable fixed rate conventional loan, and the term of the loan is less than the reference term.

23. The lending instrument of claim 19, wherein the initial payment is greater than or equal to an interest only portion of a comparable fixed rate conventional loan having a similar interest rate, principal, and term.

24. The lending instrument of claim 19, wherein the stream of payments comprises interest-only portions, a sum of the interest-only portions being equal to or less than total interest paid with an equivalent fixed rate conventional loan.

25. The lending instrument of claim 19 further comprising a buydown that is included as an increase in the principal or a decrease in the initial payment.

26. The lending instrument of claim 19, wherein the stream of payments comprises a plurality of fixed last payments.

27. The lending instrument of claim 26, wherein the stream of payments increases during half or more of the loan term.

28. The lending instrument of claim 19, wherein an interest rate used to determine the stream of payments is higher than an interest rate for a comparable fixed rate conventional loan.

29. The method of claim 1, wherein the stream of the payments is defined by the initial payment for a prespecified period of time and subsequent payments comprising the initial payment adjusted one or more times by the growth rate at prespecified intervals during the loan term.

30. The method of claim 29, wherein the calculating of the growth rate comprises selecting a growth rate; and wherein the subsequent payments further comprise one or more secondary adjustments.

31. The method of claim 30, wherein the secondary adjustment comprises a lump sum payment at the end of the loan term, the lump sum payment equal to an outstanding balance reflecting a difference between the stream of the payments and a needed stream of payments that achieves the present value.

32. The method of claim 30, wherein the secondary adjustment comprises a second stream of payment that amortizes an outstanding balance that reflects a difference between the stream of the payments and a needed stream of payments that achieves the present value.

33. The method of claim 30, wherein the selected growth rate is a whole of fraction of a percentage.

34. The method of claim 30, wherein the selected growth rate is a whole or fraction of basis points.

35. The lending instrument of claim 10, wherein the stream of the payments is defined by the initial payment for a prespecified period of time and subsequent payments comprising the initial payment adjusted one or more times by the growth rate at prespecified intervals during the loan term.

36. The lending instrument of claim 35, wherein the calculating of the growth rate comprises selecting a growth rate; and wherein the subsequent payments further comprise one or more secondary adjustments.

37. The lending instrument of claim 36, wherein the secondary adjustment comprises a lump sum payment at the end of the loan term, the lump sum payment equal to an outstanding balance reflecting a difference between the stream of the payments and a needed stream of payments that achieves the present value.

38. The lending instrument of claim 36, wherein the secondary adjustment comprises a second stream of payment that amortizes an outstanding balance that reflects a difference between the stream of the payments and a needed stream of payments that achieves the present value.

39. The lending instrument of claim 36, wherein the selected growth rate is a whole of fraction of a percentage.

40. The lending instrument of claim 36, wherein the selected growth rate is a whole or fraction of basis points.

41. The lending instrument of claim 19, wherein the stream of the payments is defined by the initial payment for a prespecified period of time and subsequent payments comprising the initial payment adjusted one or more times by the growth rate at prespecified intervals during the loan term.

42. The lending instrument of claim 41, wherein the calculating of the growth rate comprises selecting a growth rate; and wherein the subsequent payments further comprise one or more secondary adjustments.

43. The lending instrument of claim 42, wherein the secondary adjustment comprises a lump sum payment at the end of the loan term, the lump sum payment equal to an outstanding balance reflecting a difference between the stream of the payments and a needed stream of payments that achieves the present value.

44. The lending instrument of claim 42, wherein the secondary adjustment comprises a second stream of payment that amortizes an outstanding balance that reflects a difference between the stream of the payments and a needed stream of payments that achieves the present value.

45. The lending instrument of claim 42, wherein the selected growth rate is a whole of fraction of a percentage.

46. The lending instrument of claim 42, wherein the selected growth rate is a whole or fraction of basis points.

47. A computer program embodied on a computer readable medium for calculating a lending instrument, the computer program comprising:
a first code segment that is configured to receive a principal to be borrowed, an interest rate charged for the principal, a term, and an initial payment; and
a second code segment that is configured to calculate a stream of payments for the lending instrument, as defined by the initial payment, the loan term, and a growth rate, the stream of the payments having a present value equal to the borrowed principal, the present value calculated using the interest rate.

48. The computer program of claim 47, wherein the stream of the payments comprises:
the initial payment for a prespecified period of time; and
subsequent payments comprising the initial payment adjusted one or more times by the growth rate at prespecified intervals during the loan term.

49. The computer program of claim 48, wherein the first code segment receives the growth rate; and wherein the subsequent payments further comprise one or more secondary adjustments.

50. The computer program of claim 48, wherein the second code section calculates the secondary adjustments, and wherein the secondary adjustment comprises a lump sum payment at the end of the loan term, the lump sum payment equal to an outstanding balance reflecting a difference between the stream of the payments and a needed stream of payments that achieves the present value.

51. The computer program of claim 48, wherein the second code section calculates the secondary adjustments, and wherein the secondary adjustment comprises a second stream of payment that amortizes an outstanding balance that reflects a difference between the stream of the payments and a needed stream of payments that achieves the present value.
